(19) United States
(12) Patent Application Publication
(10) Pub. No.: US 2010/0093279 A1
(43) Pub. Date: Apr. 15, 2010

(54) ELECTRONIC DEVICES FOR COMMUNICATION UTILIZING ENERGY DETECTION AND/OR FREQUENCY SYNTHESIS

(75) Inventors: Joel Benjamin Linsky, San Diego, CA (US); Gene Fong, San Diego, CA (US); Faramarz Sabouri, San Diego, CA (US); Eugene Yang, San Diego, CA (US); Desong Zhao, San Diego, CA (US); Mark Lane, San Diego, CA (US); Thomas P. Cargill, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/251,356

(22) Filed: Oct. 14, 2008

(51) Int. Cl. H04B 7/00

(52) U.S. Cl. 455/41.2

(57) ABSTRACT

An electronic device for communication comprises a processor. The processor comprises a power scan module configured to receive an energy detection signal identifying detection of energy of a page signal or an inquiry signal. The power scan module is further configured to provide, upon receiving the energy detection signal, an instruction to perform a page scan or an inquiry scan.

### BACKGROUND

Bluetooth wireless technology enables short-range wireless communication among electronic devices. For example, Bluetooth technology may be used to enable wireless communication between a cellular phone and a wireless headset, between a laptop and a wireless mouse, and between other devices. Electronic devices that may use Bluetooth include, among others, cellular phones, personal digital assistance (PDA) devices, laptops, wireless headset, wireless mouse, and wireless keyboard.

Bluetooth enabled devices can be connected to one another in several different modes including active, hold, sniff, and park modes. Bluetooth enabled devices also include a page scan mode and an inquiry scan mode. In the page scan mode, a page scanning device periodically scans for page packets from other devices attempting to establish a connection with the device. A page packet includes the Device Access Code (DAC) of the device with which the paging devices is attempting to connect. When a page scanning device receives a page packet, the page scanning device demodulates the page packet to determine whether the message includes the device's DAC (i.e., whether the page message is directed to the device). In the inquiry scan mode, an inquiry scanning device periodically scans for inquiry packets from other devices attempting to discover the device. An inquiry packet includes the Inquiry Access Code (IAC). When an inquiry scanning device receives an inquiry packet, the inquiry scanning device demodulates the inquiry packet to determine whether the message includes the IAC. If the received packet includes the IAC, then the inquiry scanning device sends a response to the inquiring device.

A Bluetooth enabled device may operate in the page scan mode and/or inquiry scan most of the time. Therefore, systems and methods for reducing power in the page scan mode and inquiry scan are desired to extend the battery life of the device.

### SUMMARY

The following presents a simplified summary of various configurations of the subject technology in order to provide a basic understanding of some aspects of the configurations. This summary is not an extensive overview. It is not intended to identify key/critical elements or to delineate the scope of the configurations disclosed herein. Its sole purpose is to present some concepts in a simplified form as a prelude to the more detailed description that is presented later.

In one aspect of the disclosure, an electronic device for communication comprises a processor. The processor comprises a power scan module configured to receive an energy detection signal identifying detection of energy of a page signal or an inquiry signal. The power scan module is further configured to provide, upon receiving the energy detection signal, an instruction to perform a page scan or an inquiry scan.

In another aspect of the disclosure, a machine-readable medium comprises instructions executable by a processor. The instructions comprise code for receiving an energy detection signal identifying detection of energy of a page signal or an inquiry scan, and upon receiving the energy detection signal, providing an instruction to perform a page scan or an inquiry scan.

In a further aspect of the disclosure, an electronic device for communication comprises an energy detection system comprising. The energy detection system comprises an amplifier configured to amplify a page signal or an inquiry signal received by an antenna, and an energy detector configured to receive the amplified page signal or amplified inquiry signal and to output a detection signal when energy of the amplified page signal or amplified inquiry signal is equal to or greater than a threshold.

In yet a further aspect of the disclosure, an electronic device for communication comprises means for receiving a page signal or an inquiry signal, means for amplifying the received page signal or inquiry signal, and means for outputting a detection signal when energy of the amplified page signal or the amplified inquiry signal is equal to or greater than a threshold.

In yet a further aspect of the disclosure, an electronic device for communication comprises a frequency synthesizer. The frequency synthesizer comprises a first reference signal generator configured to generate and output a first reference signal and a second reference signal generator configured to generate and output a second reference signal. The frequency synthesizer further comprises a Phase-Locked Loop (PLL) configured to generate a first oscillator signal from the first reference signal and to generate a second oscillator signal from the second reference signal, and a switch configured to input either the first reference signal to the PLL or the second reference signal to the PLL based on a control signal.

In yet a further aspect of the disclosure, an electronic device for communication comprises means for receiving a first reference signal and means for receiving a second reference signal. The electronic device further comprises means for inputting either the first reference signal or the second reference signal to a Phase-Locked Loop (PLL) based on a control signal, and means for generating a first oscillator signal when the first reference signal is inputted to the PLL or generating a second oscillator signal when the second reference signal is inputted to the PLL.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a conceptual block diagram illustrating an example of a wireless electronic device in a wireless communication system.

FIG. 2 is a diagram illustrating an example of a Bluetooth packet.

FIG. 3 is a diagram illustrating an example of power consumption in a page scan mode.

FIGS. 4A and 4B are conceptual block diagrams illustrating another example of a wireless electronic device in a wireless communication system.

FIG. 5 is a diagram illustrating power consumption in an energy scan mode.

FIG. 6A is a flowchart illustrating an example of a low power process.

FIG. 6B is a timing diagram illustrating an example of timing for the process in FIG. 6A.

FIG. 7A is a flowchart illustrating another example of a low power process.

FIG. 7B is a timing diagram illustrating an example of timing for the process in FIG. 7A.

FIG. 8 is a timing diagram illustrating an example of timing for a further example of a low power process.

FIG. 9A is a flowchart illustrating yet another example of a low power process.

FIG. 9B is a timing diagram illustrating an example of timing for the process in FIG. 9A.

FIG. 10 is a conceptual block diagram illustrating an example of a receiver.

FIG. 11 is a conceptual block diagram illustrating an example of an energy detection system.

FIG. 12A is a conceptual block diagram illustrating an example of an energy detector.

FIG. 12B is a conceptual block diagram illustrating another example of an energy detection system.

FIG. 13 is a conceptual block diagram illustrating a further example of an energy detection system.

FIG. 14 is a conceptual block diagram illustrating yet another example of an energy detection system.

FIG. 15 is a conceptual block diagram illustrating an example of a frequency synthesizer.

FIG. 16 is a conceptual block diagram illustrating another example of a frequency synthesizer.

FIG. 17 is a conceptual block diagram illustrating an example of a dual-mode frequency synthesizer.

FIG. 18 is a conceptual block diagram illustrating an example of a loop filter.

FIG. 19 is a conceptual block diagram illustrating an example of a modulus controller.

FIG. 20 is a conceptual block diagram illustrating an example of the functionality of an electronic device.

FIG. 21 is a conceptual block diagram illustrating another example of the functionality of an electronic device.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

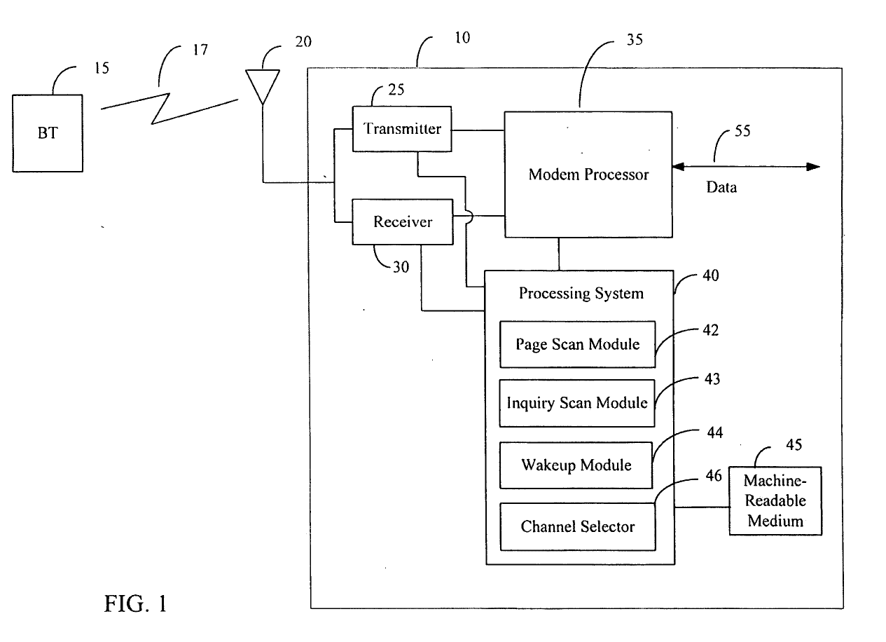

FIG. 1 is a conceptual block diagram illustrating a Bluetooth enabled device 10 that is connectable to at least one other Bluetooth enabled device 15 via a wireless link 17 according to an aspect of the disclosure. By way of illustration and not limitation, each device 10 and 15 may be a cellular phone, a personal digital assistant (PDA), a laptop computer, a wireless headset, or a wireless mouse. The Bluetooth enabled device 10 may comprise an antenna 20, a transmitter 25, a receiver 30, and a modem processor 35, which may be configured to process data for transmission to other Bluetooth enabled device 15 or process data received from the other Bluetooth enabled device 15. To transmit data 55 to the other Bluetooth device 15, the modem processor 35 may process the data 55 into one or more Bluetooth packets, modulate the one or more Bluetooth packets and send the resulting signal to the transmitter 25. The data 55 may come from other subsystems (not shown) in the device 10, e.g., a cellular subsystem, desiring to transmit data via a Bluetooth link. The modem processor 35 may perform Gaussian Frequency Shift Keying (GFSK) modulation and/or Phase Shift Keying modulation on the packets. The transmitter 25 may then process (by way of illustration and not limitation, amplify or frequency up-convert) the signal for transmission from the antenna 20. To receive data from the other Bluetooth device 15, the receiver 30 may process (by way of illustration and not limitation, amplify, frequency down-convert, or filter) a signal received by the antenna 20 and send the resulting signal to the modem processor 35. The modem processor 35 may then demodulate the signal to recover the data from the Bluetooth packet in the received signal, and send the recovered data to another subsystem of the device 10. The other Bluetooth enabled device 15 may include similar components (not shown) for enabling Bluetooth connectivity.

The Bluetooth enabled devices 10 and 15 may transmit and receive Bluetooth packets, for example, at around the 2.4 GHz Industrial, Scientific and Medical (ISM) frequency band. Each device 10 and 15 may transmit and receive Bluetooth packets using a frequency hopping scheme to reduce interference and fading. In one example, the devices 10 and 15 may use a scheme comprising 79 or fewer different hop frequencies spaced 1 MHz apart within a frequency range of 2.402 to 2.480 GHz. Each hop frequency may be referred to as a channel with 79 different channels in the example given above. These are merely examples, and the subject technology is not limited to these examples.

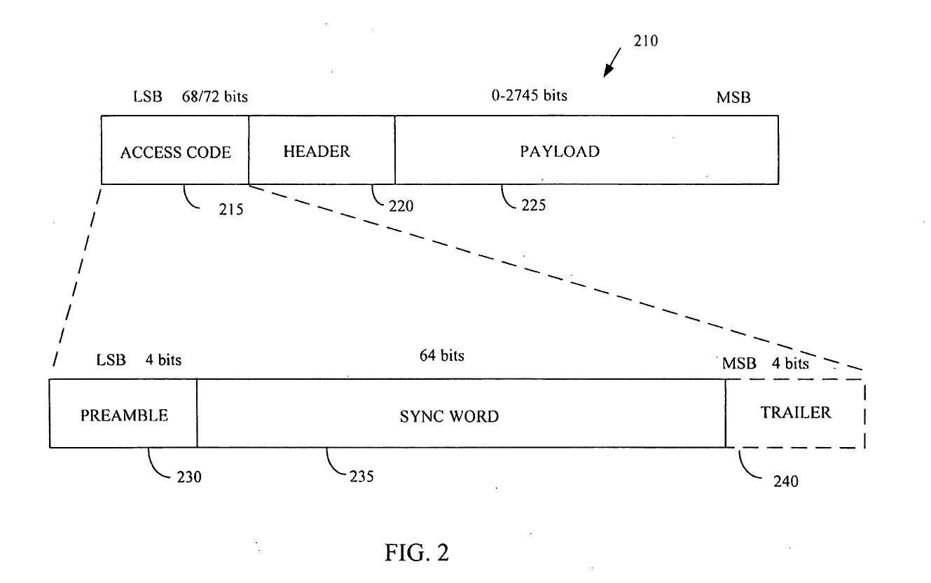

FIG. 2 shows an example of a Bluetooth packet 210 according to an aspect of the disclosure. The Bluetooth packet 210 includes an access code 215, a header 220, and an optional payload 225. By way of illustration and not limitation, the access code 215 may be 68 or 72 bits, the header 220 may be 54 bits, and the payload 225 may be 0 to 2745 bits. FIG. 2 also shows a more detailed view of the access code 215. The access code 215 includes a preamble 230, a sync word 235, and a trailer 240. By way of illustration and not limitation, the preamble 230 may be 4 bits, the sync word 235 may be 64 bits, and the trailer 240, when present, may be 4 bits. Additional details of the Bluetooth packet in FIG. 2 and examples of other types of Bluetooth packets may be found, e.g., at Specification of the Bluetooth System, Volume 2, Part B, Section 6.

In a page scan mode, a page scanning device periodically scans for page packets from other devices attempting to establish a connection with the page scanning device. A page packet may be, for example, a type of Bluetooth packet that only comprises the access code 215 identifying the device being paged. Referring to the example in FIG. 2, a page packet may, for example, only comprise the 4-bit preamble 230 and the 64-bit synch word 235 of the access code 215 and therefore only comprise 68 bits. The page packet in this example does not include the trailer 240 because the access code is not followed by a header in the page packet. This is indicated by the dashed line around the trailer in FIG. 2. For an example of a symbol rate of 1 megasymbols per second (msps), the page packet in this example is 68 μs long. The sync word 235 of the page packet may include the Device Access Code (DAC) of the device being paged.

In an inquiry scan mode, an inquiry scanning device periodically scans for inquiry packets from another device attempting to discover the presence of other Bluetooth enabled devices in its vicinity. An inquiry packet may be, for example, a type of Bluetooth packet that comprises the access code 215, where the access code 215 includes an Inquiry Access Code (IAC). The inquiry packet may have the same length (e.g., 68 μs) as a page packet. The inquiry packet may be transmitted using an inquiry channel hopping sequence, e.g., based on the IAC and a local clock of the inquiring device.

Examples of operations in a page scan mode will now be given with reference to FIG. 1. For purposes of the following discussion, the device 10 is designated as a page scanning device, and the device 15 is designated as a paging device attempting to establish a connection with the page scanning device 10, although it is to be understood that their roles can be reversed.

In one aspect, a page scanning device 10 may include a processing system 40 comprising a page scan module 42, a wakeup module 44, and a channel selector 46. The processing system 40 may be implemented using software, hardware, or a combination of both. Software shall be construed broadly to mean instructions, data, or any combination thereof, whether referred to as software, firmware, middleware, microcode, hardware description language, or otherwise. By way of example, the processing system 40 may be implemented with one or more processors. A processing system is sometimes referred to as a processor. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. A processor may include both the modem processor 35 and the processing system 40. A processor may include one or more processors.

The pages scanning device 10 may also include a machine-readable medium 45 that is operatively coupled to the processing system 40 and that can store information related to data processing. A machine-readable medium may be placed outside and/or inside the processing system 40 and/or the modem processor 35. A machine-readable medium may be one medium or a plurality of media.

A machine-readable medium may include storage integrated into a processor, such as might be the case with an ASIC, and/or storage external to a processor such as the machine-readable medium 45. By way of illustration, and not limitation, machine-readable media may include one or more of volatile memory, nonvolatile memory, a Random Access Memory (RAM), a flash memory, a Read Only Memory (ROM), a Programmable Read-Only Memory (PROM), an Erasable PROM (EPROM), a register, a hard disk, a removable disk, a CD-ROM, a DVD, or any other suitable storage device. In addition, machine-readable media may include a transmission line or a carrier wave that encodes a data signal. A machine-readable medium may be a computer-readable medium encoded or stored with a computer program or instructions. The computer program or instructions may be executable by a transmitter or receiver device or by a processing system of a transmitter or receiver device.

In one aspect of the disclosure, the page scan module 42 may be configured to manage page scan operations of the page scanning device 10, as discussed further below. The wakeup module 44 may be configured to periodically wake up the receiver 30 and the modem processor 35 to perform a page scan in the page scan mode. The wakeup module 44 may keep track of time using, e.g., a Bluetooth clock and/or a software timer. Although shown separately from the page scan module 42, the wakeup module 44 may be part of the page scan module 42. The channel selector 46 may be configured to select the channel at which the receiver 30 scans for page packets, e.g., based on a page channel hopping sequence.

In one aspect of the disclosure, the wakeup module 44 periodically wakes up the receiver 30 and the modem processor 35 from a sleep state, e.g., once every 1.28 seconds, to perform a page scan for a page scan window, e.g., 11.25 ms. When the receiver 30 receives a page packet during a page scan, the modem processor 35 demodulates the page packet and recovers the data in the page packet. The page scan module 42 may then examine the recovered data to determine whether the page packet includes the device's DAC (i.e., whether the page packet is directed to the device 10). If so, then the page scan module 42 may start procedures for establishing a connection with the paging device 15. Examples of details for establishing a connection after a page scanning device has been paged may be found, e.g., at the Specification for the Bluetooth System, Volume 2, part B, Section 8.3.

The paging device 15 may transmit the page packet using a page hopping scheme, in which the page packet is transmitted on a sequence of different channels. For example, the paging device 15 may use 32 different channels for paging. In this example, the paging device 15 may transmit the page packet using two different page trains, where each page train comprises a sequence of 16 of the 32 channels. In this example, each page train may be 10 ms long, during which time the paging device 15 transmits the page packet on each of the 16 channels in the page train. The paging device 15 may repeat the same page train, e.g., every 10 ms. In this example, the paging device 15 may alternate between the two page trains, e.g., every 1.28 seconds. The paging device 15 may algorithmically generate a page train of 16 channels based on the Bluetooth Device Address (BD_ADDR) of the paging device is attempting to page and an estimate of the page scanning device's Bluetooth clock.

As discussed above, the wakeup module 44 may periodically wake up the receiver 30 and the modem processor 35 from a sleep state to perform a page scan, e.g., once every 1.28 seconds for a page scan window of 11.25 ms. In one aspect, the channel selector 46 may select a channel at each page scan wakeup based on a page channel hopping sequence. The channel selector 46 may generate a page channel hopping sequence based on, for example, the Bluetooth Device Address (BD_ADDR) and an estimate of the Bluetooth clock of the device 10. In one aspect, the page channel hopping sequence comprises 32 different channels. The channel selector 46 may hop channels at a rate of once every 1.28 seconds (e.g., interval between page scan wakeups). In this example, the page scan window of 11.25 ms corresponds to a page train interval of 10 ms to ensure that the page scan window covers all 16 channels of the page train. The page train interval of 10 ms and the page scan window of 11.25 ms are exemplary only, and other page train intervals and page scan windows may be used.

In one aspect, the device 10 may also scan for inquiry packets in an inquiry scan mode. In this aspect, the device 10 comprises an inquiry scan module 43 to manage inquiry scans of the device 10. The wakeup module 44 may be configured to periodically wake up the receiver 30 and the modem processor 35 to perform an inquiry scan. If the device 10 receives an inquiry packet from another device, then the inquiry scan module 43 may send a response with an address and clock of the device 10 so that the other device can establish a connection with the device 10.

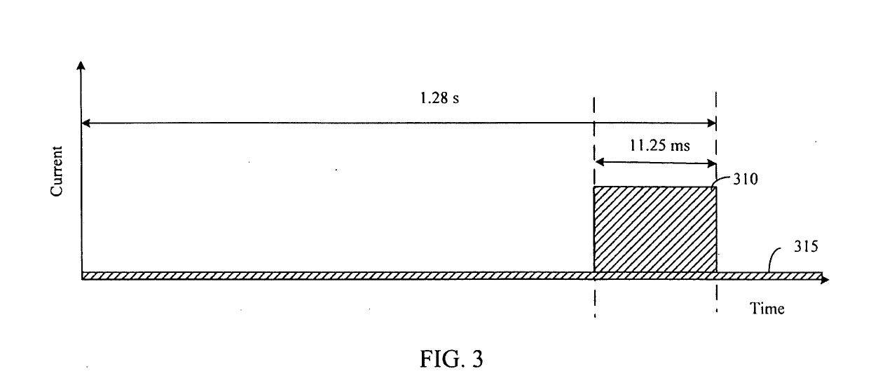

An example of power consumption in a page scan mode will now be discussed with reference to FIG. 3. FIG. 3 shows a plot of current consumption of the receiver 30 and the modem processor 35 in a page scan mode. In this example, the wakeup module 44 periodically wakes up the receiver 30 and the modem processor 35 from the sleep state every 1.28 seconds to perform a page scan for a page scan window of 11.25 ms. As shown in FIG. 3, during the sleep state, current consumption is very low, e.g., due to leakage current 315 of the receiver 30 and the modem processor 35. During a page scan window, the current 310 increases since the receiver 30 and the modem processor 35 are powered on to perform a page scan. The average current consumption in the page scan mode may be approximated as:

leakage_current+(RX_current*(window/interval)) (1)

where leakage_current is the leakage current of the receiver 30 and the modem processor 35, RX_current is the current consumption during a page scan, window is the length of a page scan window (e.g., 11.25 ms), and interval is the interval between page scans (e.g., 1.28 seconds). Power consumption in a page scan mode is proportional to the average current consumption in the page scan mode. In the example above, the page scanning device performs page scanning at a duty cycle of approximately 1% (11.25 ms/1.28 seconds).

Based on equation (1), there are at least three ways to reduce average current consumption, and hence power consumption, in a page scan mode. These may include the following:

1. Increase the interval between page scans;

2. Decrease the length of the page scan window; and

3. Decrease the current during a page scan.

Aspects of the disclosure may use one or more of the above ways to reduce power consumption in the page scan mode. The above discussion of power consumption in the page scan mode also applies to the inquiry scan mode. Thus, systems and methods for reducing power in the page scan mode can also be applied in the inquiry scan mode.

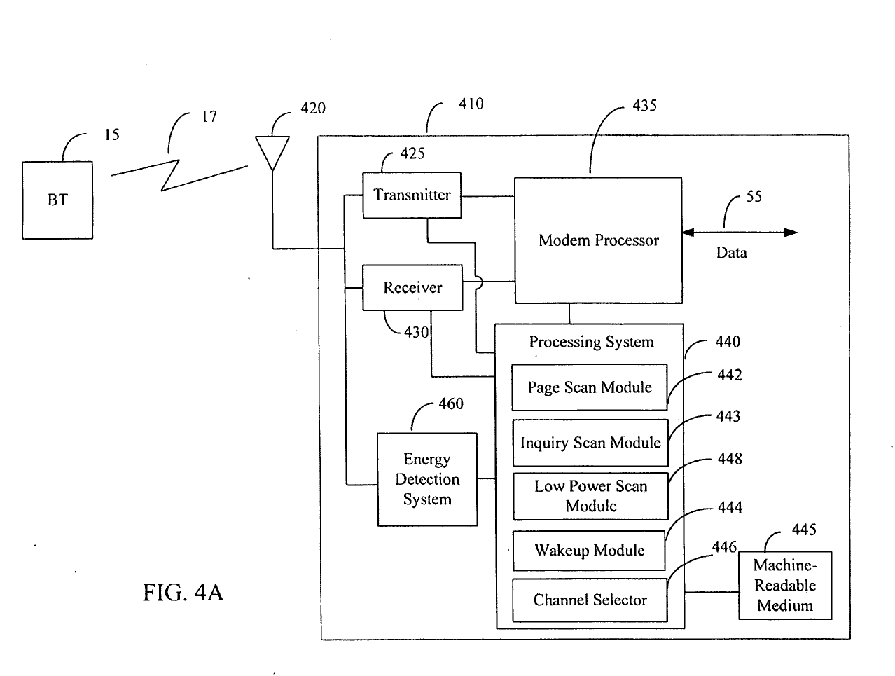

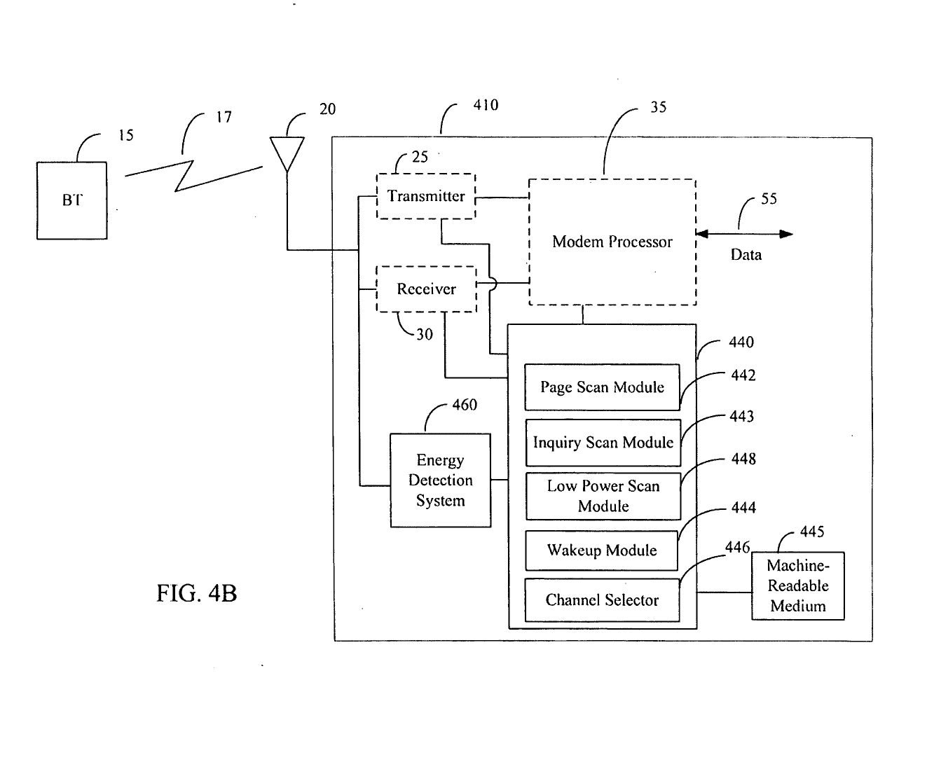

FIG. 4A is a conceptual block diagram of a Bluetooth enabled device 410 for reducing power consumption according to an aspect of the disclosure. In this aspect, the Bluetooth enabled device 410 comprises an antenna 420, a receiver 430, and a modem processor 435 for performing a page scan by receiving and demodulating page packets. The Bluetooth enabled device 410 may also include a transmitter 425.

The Bluetooth enabled device 410 further comprises an energy detection system 460 coupled to the antenna 420 and configured to detect energy of a page packet received by the antenna 420. The energy detection system 460 may also detect the energy of an inquiry packet. The Bluetooth enabled device 410 also includes a processing system 440 comprising a page scan module 442, a low power scan module 448, a wakeup module 44, and a channel selector 446. The Bluetooth enabled device 410 may also include an inquiry scan module 443. The processing system 440 may be implemented using software, hardware, or a combination of both. Software shall be construed broadly to mean instructions, data, or any combination thereof, whether referred to as software, firmware, middleware, microcode, hardware description language, or otherwise. By way of example, the processing system 440 may be implemented with one or more processors. A processing system is sometimes referred to as a processor. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. A processor may include both the modem processor 435 and the processing system 440. A processor may include one or more processors.

The Bluetooth enabled device 410 also includes a machine-readable medium 445 that is operatively coupled to the processing system 440 and that can store information related to data processing. A machine-readable medium may be placed outside and/or inside the processing system 440 and/or the modem processor 435. A machine-readable medium may be one medium or a plurality of media.

A machine-readable medium may include storage integrated into a processor, such as might be the case with an ASIC, and/or storage external to a processor such as the machine-readable medium 445. By way of illustration, and not limitation, machine-readable media may include one or more of volatile memory, nonvolatile memory, a Random Access Memory (RAM), a flash memory, a Read Only Memory (ROM), a Programmable Read-Only Memory (PROM), an Erasable PROM (EPROM), a register, a hard disk, a removable disk, a CD-ROM, a DVD, or any other suitable storage device. In addition, machine-readable media may include a transmission line or a carrier wave that encodes a data signal. A machine-readable medium may be a computer-readable medium encoded or stored with a computer program or instructions. The computer program or instructions may be executable by a transmitter or receiver device or by a processing system of a transmitter or receiver device.

In one aspect of the disclosure, the Bluetooth enabled device 410 may perform an energy scan, in which the energy detection system 460 is used to detect the energy of a page packet received by the antenna 420. The receiver 430 and/or the modem processor 435 may be powered off during the energy scan mode to conserve power. The Bluetooth enabled device 10 may also perform a page scan, in which the receiver 430 and the modem processor 435 are powered on to receive and demodulate (e.g., GFSK demodulate) a page packet to determine whether the device 410 is being paged. In this aspect, the wakeup module 444 may periodically wakeup the energy detection system 460 to perform an energy scan. When the energy detection system 460 detects the energy of a page packet, the energy detection system 460 may send a detection signal to the low power scan module 448. Upon receiving the detection signal, the low power scan module 448 may instruct the page scan module 442 to schedule a page scan, as discussed further below. An energy scan consumes less power than a page scan by detecting the energy of a received page packet instead of trying to demodulate the page packet to recover data in the packet, which requires more power.

The energy detection system 460 may detect the energy of a page packet, e.g., by detecting received energy that is above a predetermined threshold and that is within a predetermined frequency band. For example, the energy detection system may detect received energy within a frequency band centered at a channel selected by the channel selector 446. The term “predetermined threshold” may refer to, for example, a threshold that is determined prior to utilizing the threshold. In this example, the frequency band may correspond to the frequency band of a page packet, which may be 1 MHz. This has an advantage of removing out-of-band blockers from the received signal. This also has the advantage of reducing the energy of blockers having wider bandwidths than a page packet, such as WLAN signals which may have bandwidths of 20 MHz to 40 MHz. Thus, the energy detection system may employ band-pass filtering to remove blockers and therefore reduce the rate of false detections.

In another example, the energy detection system 460 may detect received energy having a similar shape to a page packet. For example, for a page packet having a length of 68 μs, the energy detection system 460 may be configured to detect received energy that is above a threshold for a duration of approximately 68 μs. This has an advantage of eliminating Bluetooth connection packets and/or most WLAN packets having packet lengths that differ from the length of a page packet.

Thus, the energy detection system 460 may be configured to detect received energy that is characteristic of a page packet (e.g., 1 MHz bandwidth, 68 μs length, or other bandwidth/length). Exemplary implementations of energy detection systems are given below.

In one aspect, the energy detection system 460 may also detect the energy of an inquiry packet. An inquiry packet may have the same or similar length (e.g., 68 μs), packet structure and/or bandwidth as a page packet. Thus, the energy detection techniques for detecting the energy of a page packet can be applied to detect the energy of an inquiry packet. In this aspect, the low power scan module 448 may be configured to instruct the inquiry scan module 443 to perform an inquiry scan when the energy of an inquiry packet is detected in an inquiry scan mode.

The wakeup module 444 may be configured to periodically wake up the energy detection system 460 from a sleep state to perform an energy scan. For example, the wakeup module 460 may periodically wake up the energy detection system 460, e.g., once every 1.28 seconds for a duration of 11.25 ms. The receiver 30 and the modem processor 35 remain in the sleep state while the energy detection system 460 performs an energy scan. This is depicted in FIG. 4B, in which the dashed lines around the transmitter 425, receiver 430 and the modem processor 435 indicate that they are in the sleep state while the energy detection system 460 scans for the energy of a page packet. If the energy detection system 460 detects the energy of a page packet, then the low power scan module 448 may instruct the page scan module 442 to schedule a page scan. In this example, the device 410 saves power in the page scan mode by periodically waking up the energy detection system 460 to perform an energy scan, and scheduling a page scan when the energy of a page packet is detected. Thus, the energy detection system 460 prescreens for page packets by detecting their energy, and the low power scan module 448 initiates a page scan when the energy of a page packet is detected. Similarly, in an inquiry scan mode, the energy detection system 460 may be used to detect the energy of an inquiry packet to prescreen for inquiry packets, and the low power scan module 448 may initiate an inquiry scan when the energy of an inquiry packet is detected.

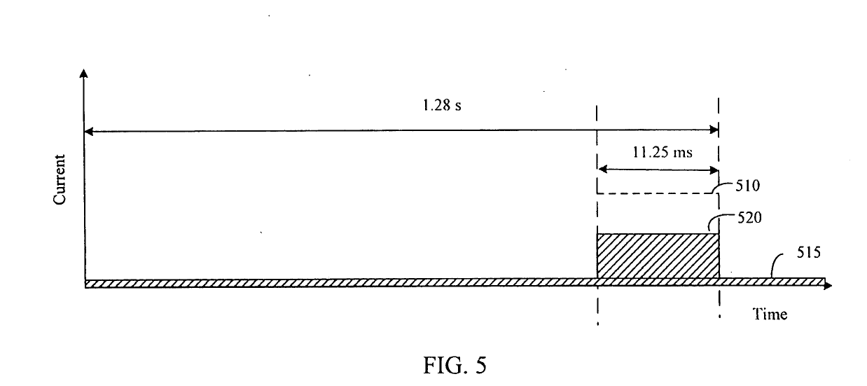

FIG. 5 shows an example of a plot of current consumption of the energy detection system 460 in the energy scan mode. In the example in FIG. 5, the wakeup module 444 periodically wakes up the energy detection system 460 from the sleep state every 1.28 seconds to perform an energy scan for a duration of 11.25 ms. As shown in FIG. 5, the current 520 consumed by the energy detection system 460 is less than the current 510 consumed by the receiver 430 and the modem processor 435 in a page scan, which is shown by a dashed line.

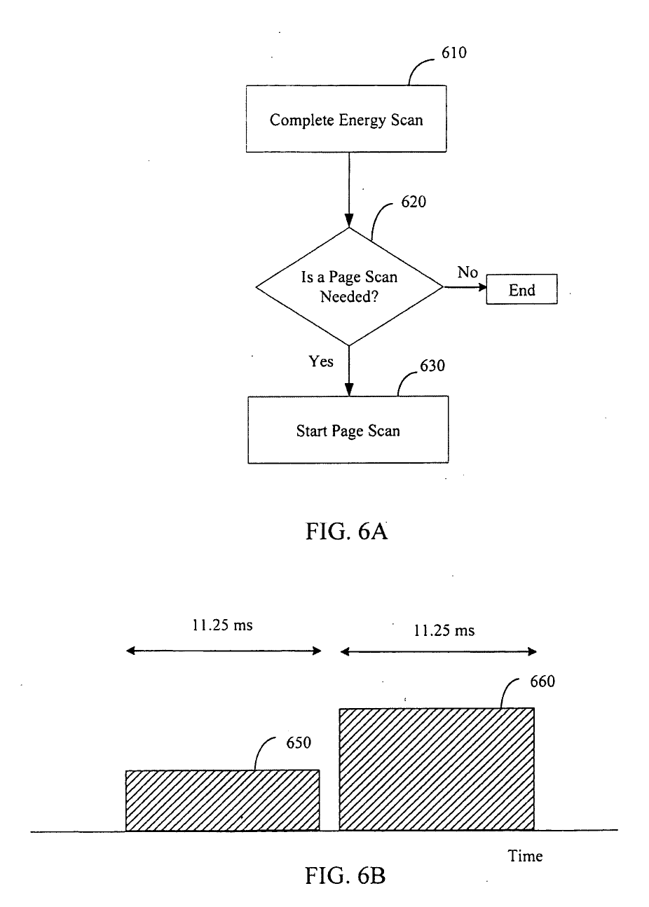

Examples of processes that may be performed by the low power scan module 448 will now be discussed. FIG. 6A is a flowchart illustrating a process that may be performed by the low power scan module 448 according to one aspect of the disclosure. In step 610, the low power scan module 448 has the energy detection system 460 complete an energy scan. In step 620, the low power scan module 448 determines whether a page scan is needed. For example, the low power scan module 448 may determine that a page scan is needed if the energy detection system 460 detects the energy of a page packet during the energy scan. If a page scan is not needed, then the process ends. If a page scan is needed, then the low power scan module 448 instructs the page scan module 442 to start a page scan in step 630.

FIG. 6B is an example of a timing diagram illustrating the timing of an energy scan 650 and a page scan 660 for the process in FIG. 6A. In this example, the duration of the energy scan 650 is 11.25 ms, although other durations may also be used. The lower height of the energy scan 650 indicates that it consumes less current, and hence less power, than the page scan 660. In this example, the low power scan module 448 determines that a page scan is needed and schedules the page scan 660 after the energy scan 650 is complete. In this example, the page scan 660 has a page scan window of 11.25 ms, although the page scan window may have other lengths, e.g., depending on the length of a page train used by the paging device.

The process in FIGS. 6A and 6B may also be applied in the inquiry scan mode, in which the low power module may determine whether an inquiry scan is needed (e.g., energy of an inquiry packet is detected) and instruct the inquiry scan module 443 to start an inquiry scan if an inquiry scan is needed.

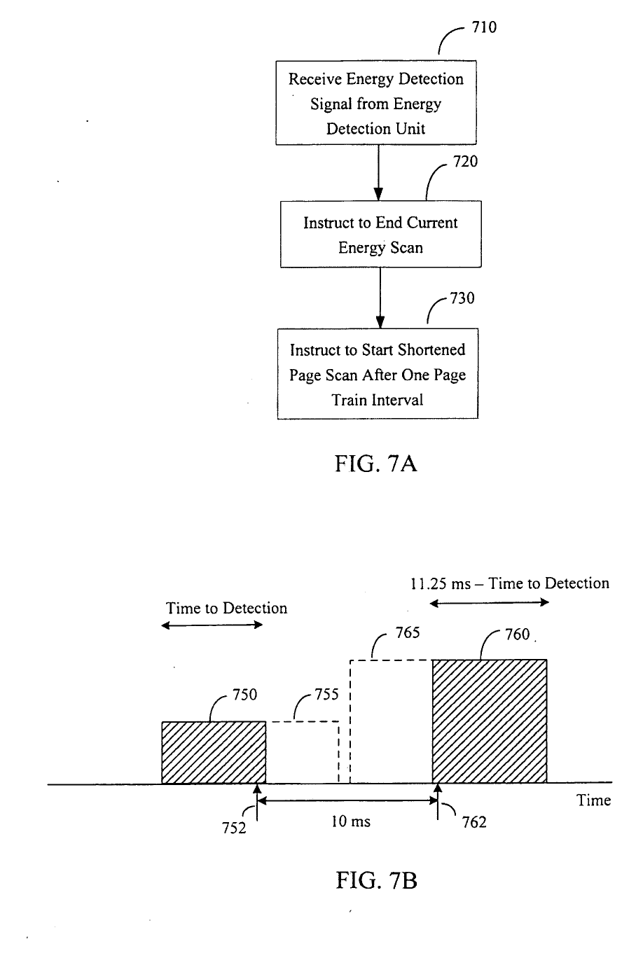

FIG. 7A is a flowchart illustrating a process that may be performed by the low power scan module 448 according to another aspect of the disclosure. In step 710, the low power scan module 448 receives an energy detection signal from the energy detection system 460 during an energy scan, where the detection signal indicates that the energy of a page packet has been detected. In step 720, the low power scan module 448 instructs the energy detection system 460 to end the current energy scan to conserve power. In step 730, the low power scan module 448 instructs the page scan module 442 to start a shortened page scan after approximately one page train interval (e.g., 10 ms) from the time of energy detection. In one aspect of the disclosure, the duration of the shortened page scan is approximately the duration of a full-length page scan (e.g., 11.25 ms) minus the time to energy detection during the energy scan. The shortened page scan interval advantageously reduces the power used to perform the page scan and therefore reduces the cost of a false detect. A module such as a low power scan module can instruct another module or a system to perform a function by, for example, providing a command or a signal.

FIG. 7B is an example of a timing diagram illustrating the timing of an energy scan 750 and a shortened page scan 760 for the process in FIG. 7B. In this example, the energy scan 750 is stopped when (or shortly after) the energy of a page packet is detected at time 752. Stopping the energy scan reduces power consumption compared with completing the energy scan. In FIG. 7B, the area within the dashed line 755 indicates the power that is saved by stopping the energy scan 750 in this example. After approximately one page train interval from the time 752 of energy detection, the shortened page scan 760 starts. In the example in FIG. 7B, one page train interval is approximately 10 ms. The duration of the shortened page scan 760 is approximately the duration of a full-length page scan (e.g., 11.25 ms) minus the time to energy detection during the energy scan 750. In FIG. 7B, the area within the dashed line 765 indicates the power that is saved by shortening the duration of the page scan 760.

In this aspect, the shortened page scan starts at approximately one page train interval after the time of energy detection so that the channel at which the page packet is transmitted at the beginning of the page scan is the same as the channel at which the device performs the page scan. This is based on the assumption that each channel of the page train repeats every page train interval (e.g., 10 ms) and that the energy scan and the page scan are performed at the same channel. Thus, if the energy detection system detects 460 the page packet on a certain channel, then the page packet will be transmitted again on the same channel at the beginning of the page scan (one page train interval after the time of energy detection). This aspect saves power by using a shortened page scan. As shown in the example in FIG. 7B, the shortened page scan 760 may be started slightly before one page train interval after the time of energy detection to provide a time margin for the receiver 430 and the modem processor 435 to fully power on.

The process in FIGS. 7A and 7B may also be applied in the inquiry scan mode to schedule an inquiry scan after the energy of an inquiry packet is detected. For example, an inquiring device may transmit an inquiry packet using an inquiry train comprising a sequence of channels. The inquiring device may transmit the inquiry packet on each of the channels in the inquiry train and may repeat the inquiry train every inquiry train interval. In this example, when the energy of an inquiry packet is detected, the low power scan module may end the current energy scan and start an inquiry scan after approximately one inquiry train interval from the time of energy detection.

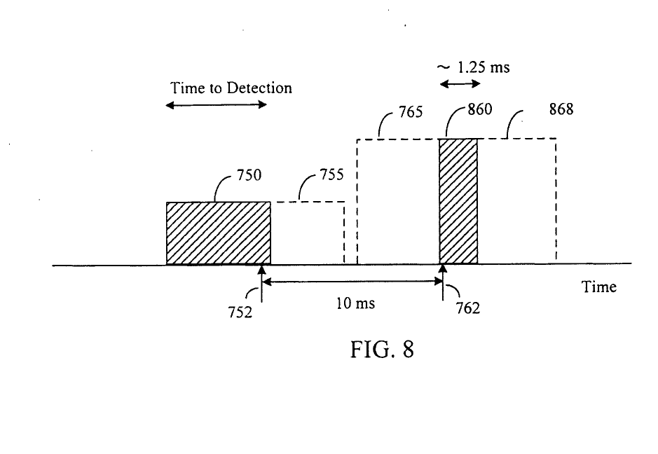

FIG. 8 is a timing diagram illustrating the timing of a shortened page scan 860 that may be used in the process in FIG. 7A according to another aspect of the disclosure. In this aspect, the shortened page scan 860 starts at approximately one page train interval after the time of energy detection in a manner similar to the previous aspect. However, the duration of the shortened page scan 860 may be approximately two timeslots (e.g., 2*0.625 ms) or any number of timeslots. This aspect is based on the idea that the page scan 860 can successfully scan a page packet within one frame at approximately the same channel at which the energy of the page packet was detected during the energy scan. In FIG. 8, the area within the dashed line 868 indicates the power that is saved compared with the example in FIG. 7B.

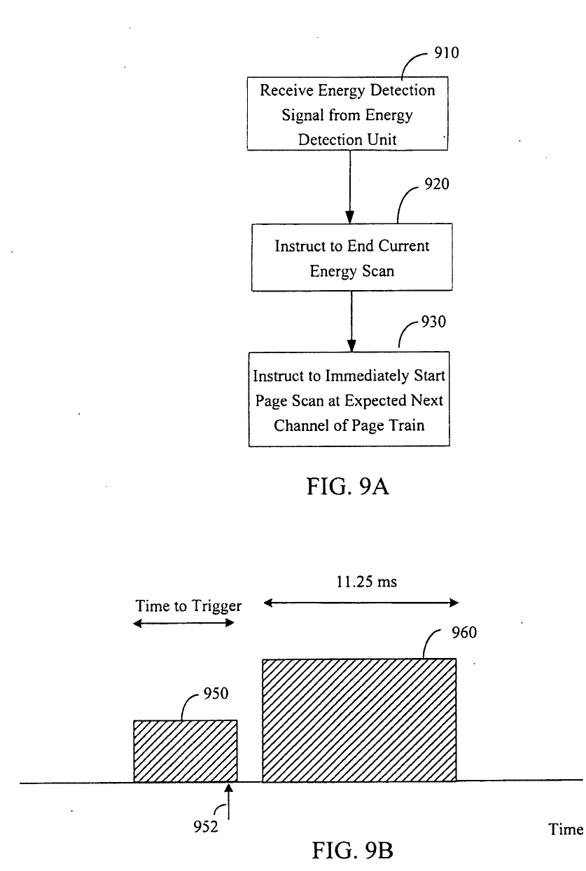

FIG. 9A is a flowchart illustrating a process that may be performed by the low power scan module 448 according to another aspect of the disclosure. In step 910, the low power scan module 448 receives an energy detection signal from the energy detection system 460 during an energy scan. In step 920, the low power scan module 448 instructs the energy detection system 460 to end the current energy scan. In step 930, the low power scan module 448 instructs the page scan module to start a page scan at an expected next channel of the page train of the paging device. The low power scan module 448 may determine the sequence of channels in the page train, e.g., by generating a page train using the same algorithm and BD_ADDR used by the paging device to generate the page train. The low power scan module 448 may also receive the page train from the paging device. After the page train is known, the low power scan module 448 may predict the next channel of the page train based on a channel at which the energy of the page packet was detected and looking for the next channel in the sequence of channels in the page train. After determining the expected next channel, the low scan module 448 may instruct the page scan module to initiate a page scan at the next expected channel. This aspect has an advantage of reducing the delay of the page scan when the device is being paged.

FIG. 9B is an example of a timing diagram illustrating the timing of an energy scan 950 and a page scan 960 for the process in FIG. 9A. In this example, the energy scan 950 is stopped when (or shortly after) the energy of a page packet is detected at time 952. A page scan 960 starts at the expected next channel of the page train. The expected next channel may be the channel in the sequence of channels in the page train that comes immediately after the channel at which the energy was detected. The expected next channel may also be the second channel that comes after the channel at which the energy was detected or a later subsequent channel, e.g., depending on how long its takes to initialize the receiver 430 and the modem processor 435 to perform the page scan 960. In the example in FIG. 9B, the page scan has a page scan window length of 11.25 ms, although it is to be understood that the page scan window may have other lengths, e.g., a shorter length to conserve power.

The process in FIGS. 7A and 7B may also be applied in the inquiry scan mode to schedule an inquiry scan after the energy of an inquiry packet is detected.

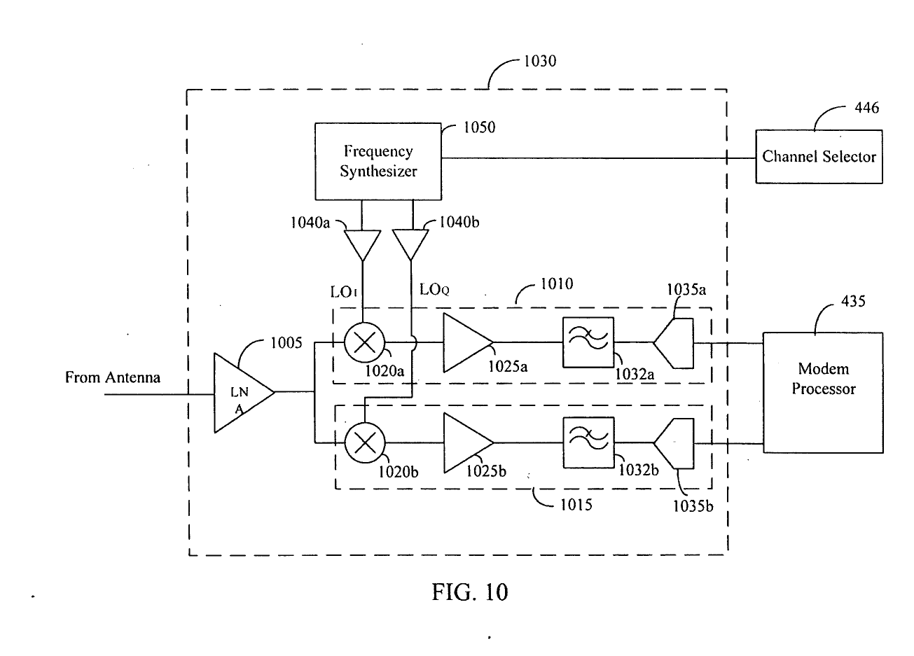

FIG. 10 is a conceptual block diagram illustrating a receiver 1030 for performing a page scan according to an aspect of the disclosure. The receiver 1030 in FIG. 10 may also be used to perform an inquiry scan in an inquiry scan mode, and receive other Bluetooth signals. The receiver 1030 may be used to implement the receiver 430 shown in FIG. 4A. The receiver 1030 includes a low noise amplifier (LNA) 1005 for amplifying a signal received by the antenna 420. The amplified signal from the LNA 1005 is split between an in-phase (I) path 1010 and a quadrature (Q) path 1015 of the receiver 1030. The path 1010 includes a mixer 1020a, a baseband amplifier 1025a, an anti-aliasing filter 1032a, and an analog-to-digital (ADC) converter 1035a. The path 1015 includes a mixer 1020b, a baseband amplifier 1025b, an anti-aliasing filter 1032b, and an analog-to-digital (ADC) converter 1035b. The receiver 1030 may further include a frequency synthesizer 1050, a buffer 1040a for the I path and a buffer 1040b for the Q path. The ADC 1035a/1035b may be implemented using a delta-sigma ADC, a flash ADC, or any other type of ADC.

In each of the paths 1010 and 1015, its corresponding mixer 1025a/1025b frequency down-converts the respective signal to baseband by mixing the signal with a local oscillator signal LO_{I}/LO_{Q} from the frequency synthesizer 1050. The local oscillator signal LO_{Q} of the mixer 1020b in the Q path 1015 is 90 degrees out of phase with the local oscillator signal LO_{I} of the mixer 1020a in the I path 1010 to provide the Q component of the signal. The frequency synthesizer 1050 may tune the frequency of the local oscillator signals LO_{I} and LO_{Q} according to a desired channel inputted from the channel selector 446. In one aspect, the local oscillator signals LO_{I} and LO_{Q} may be tuned within a frequency range of 2.402 and 2.480 GHz, which may correspond to 79 different channels spaced 1 MHz apart. Other frequency ranges and channel schemes may be used. For example, the receiver may down-convert a received RF signal to an intermediate frequency instead of baseband. The receiver in FIG. 10 is exemplary only and other receiver architectures may be used to receive a page packet or inquiry packet.

Implementation examples of the frequency synthesizer 1050 are given below. The buffers 1040a and 1040b in the local oscillator paths may be used to sharpen the edges of the local oscillator signals LO_{I} and LO_{Q} before going to the mixers 1025a and 1025b, respectively. The local oscillator paths may also include amplifiers for amplifying the local oscillator signals LO_{I} and LO_{Q}.

In each path, its corresponding baseband amplifier 1025a/1025b amplifies the respective baseband signal. The amplified output signal of the baseband amplifier 1025a/1025b is then filtered by the anti-aliasing filter 1032a/1032b to remove aliasing components before analog-to-digital conversion. The anti-aliasing filter may have an output bandwidth of approximately 700 KHz. The filtered output signal of the anti-aliasing filter 1032a/1032b is inputted to the respective ADC 1035a and 1035b to digitize the signal. The ADC 1035a and 1035b may have high linearity, high noise performance and high dynamic range (e.g., 70 dB). The digital output signals of the I and Q paths 1010 and 1015 are inputted to the modem processor 430 for digital processing. The modem processor 430 may perform demodulation (e.g., GFSK demodulation) on the digital signals to recover data in a page packet or inquiry packet of the received signal.

In a page scan mode, the channel selector 446 may hop channels based on a page channel hopping sequence. In one aspect, the channel selector 446 hops channels at a rate of one channel per page scan.

In a page scan mode or inquiry scan mode, the receiver 1030 may be powered on only 1% or less of the time, e.g., for a scan window of 11.25 ms and an interval of 1.28 seconds between page scans or 2.56 between inquiry scans. However, because a Bluetooth enabled device may operate most of the time in the page scan mode and/or inquiry scan mode, the receiver current in the page scan mode and inquiry scan mode may have a significant impact on the battery life of the device. Therefore, it is desirable to reduce current in the page scan mode and inquiry scan mode to extend the battery life of the device.

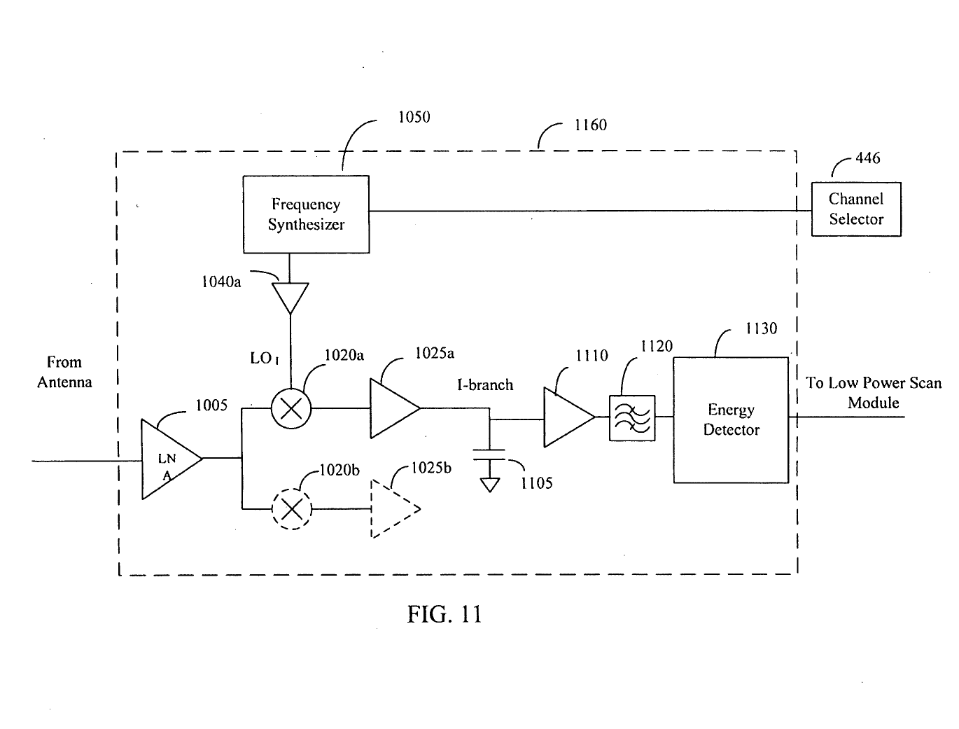

FIG. 11 is a conceptual block diagram of an energy detection system 1160 according to an aspect of the disclosure. The energy detection system 1160 may be used to implement the energy detection system 460 in FIG. 4A or 4B. A page scanning or an inquiry scanning device (e.g., a device 410 of FIG. 4A) can reduce power consumption by utilizing an energy detection system 1160 to detect the energy of a page packet or an inquiry packet instead of demodulating the page packet or the inquiry packet to recover data in the page packet or the inquiry packet.

In this aspect, the energy detection system 1160 may include components from the receiver 1030 in FIG. 10. More particularly, the energy detection system 1160 may include the LNA 1005, and the mixer 1020a and the baseband amplifier 1025a in the I path 1010 of the receiver 430. The mixer 1020b and the baseband amplifier 1025 in the Q path 1015 are dashed to indicate that they are not used in the energy detection system 1160. By not using the Q path 1015 of the receiver 1030, the energy detection system 1160 eliminates the power consumption due to the components in the Q path 1015. The energy detection system 1160 may also comprise a capacitor 1105, a second amplifier 1110, a band-pass filter 1120, and an energy detector 1130. The energy system 1160 may further comprise the frequency synthesizer 1150 for frequency down-conversion and channel selection and the buffer 1040a. In this example, components 1005, 1020a, 1025a, 1050, and 1040a are used for the receiver 1030 as well as the energy detection system 1160. In another example, the receiver 1030 and the energy detection system 1160 may utilize separate components rather than sharing the same components.

In one aspect of the disclosure, the mixer 1020a frequency down-converts the signal from the LNA 1005 at a desired channel to an intermediate frequency (IF) instead of baseband. For a GFSK modulated page or inquiry signal, the page or inquiry signal has a constant envelope when down-converted to IF, which allows all of its energy to be kept in one channel. The IF may be 4 MHz or another frequency. The IF output signal of the mixer 1020a is then amplified by the baseband amplifier 1025a, which has sufficient bandwidth to amplify the page signal at IF. The amplified output signal of the baseband amplifier 1025a is further amplified by the second amplifier 1110. The second amplifier 1110 may be used to further boost the power of the signal before energy detection, and may have a gain of 20 dB. The output signal of the second amplifier 1110 is then filtered by the band-pass filter 1120. In one aspect, the band-pass filter 1120 may be configured to have a band-pass that allows a page packet having a 1 MHz bandwidth centered at the IF to pass (e.g., 4 MHz±500 KHz) while filtering out out-of-band blockers. The band-pass filter 1120 may be implemented by a combination of a first-order low-pass filter and a first-order high-pass filter. The capacitor 1105 may be used to increase the low-pass filter to second-order to enhance filtering of blockers.

The energy detector 1130 then detects energy at the output of the band-pass filter 1120. For example, the energy detector may detect energy that is above a predetermined threshold. When energy is detected, the energy detector 1130 may send a detection signal to the low power scan module 448. Examples of types of energy detectors that may be used include root-mean square detectors, peak detectors and other types of detectors. The energy detector may be implemented in the analog or digital domain.

In one aspect, the channel selector 446 may hop channels for each energy scan based on the same page channel hopping sequence used for page scans. When energy is detected at a certain channel during an energy scan and a page scan or an inquiry scan is initiated in response to the energy detection, the page scan or the inquiry scan may be performed at the same channel at which the energy was detected. The page scan or the inquiry scan may be scheduled using any of the methods described above.

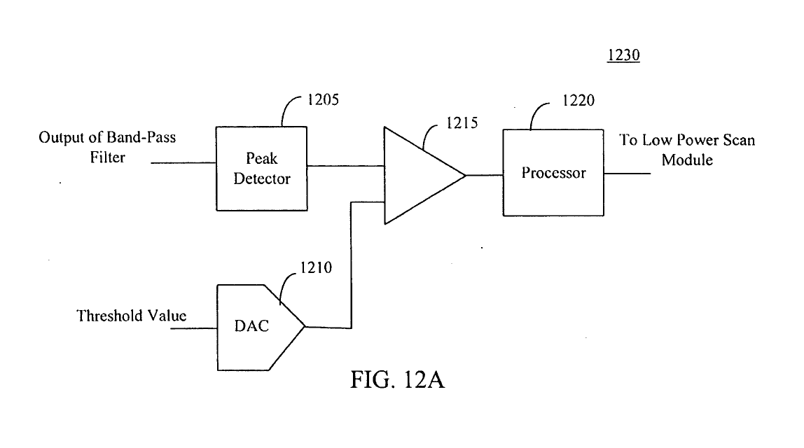

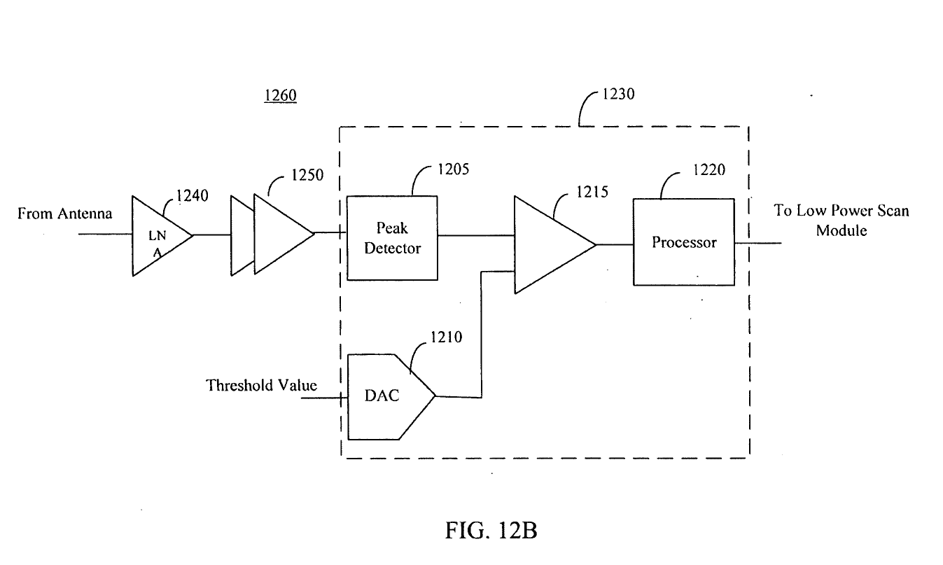

FIG. 12A is a conceptual block diagram of an energy detector 1230 according to an aspect of the disclosure. The energy detector 1230 may be used to implement the energy detector 1130 in FIG. 11. The energy detector 1230 may comprise a peak detector 1205, a threshold digital-to-analog converter (DAC) 1210 to convert a digital threshold value into an analog threshold voltage, a comparator 1215, and a processor 1220. The peak detector 1205 may be configured to output a voltage that is equal to a peak voltage of the input signal from the band-pass filter 1120. The peak voltage of the input signal measures the envelope of the input signal. For a paging or inquiry signal having a constant envelope (e.g., GFSK modulated), the energy of the paging or inquiry signal can be measured by its envelope. Thus, the output of the peak detector can be used as a measure of the energy of a paging or inquiry signal. The peak detector 1205 may be implemented, e.g., using a series combination of a diode and a capacitor to hold the peak voltage.

The peak voltage from the peak detector 1205 and the analog threshold voltage are inputted to the comparator 1215. The comparator 1215 may output a high signal when the peak voltage is above the threshold voltage indicating energy detection, and a low signal when the peak voltage is below the threshold voltage. The threshold value may be provided by the low page scan module 448 and may be set, e.g., depending on a desired sensitivity for the energy detector 1230.

The processor 1220 may detect the energy of a page packet or an inquiry packet when the comparator 1215 output is high. In one aspect, the processor 1220 may output a detection signal to the low power scan module 448 when the comparator 1215 output is high. In another aspect, the processor 1220 may keep track of a time duration for which the comparator 1215 output is high and output the detection signal, e.g., when the time duration is approximately equal to and/or greater than the duration of a page packet or inquiry packet (e.g., 68 μs).

In one aspect of the disclosure, a squaring circuit and filtering circuit may be used in place of the peak detector 1205 in the energy detector 1230. Since a GPSK modulated page or inquiry signal has a constant envelope in IF, the squaring circuit converts the page or inquiry signal to a DC voltage level, which is proportional to a peak or root-mean-square (rms) voltage of the page or inquiry signal, and a second-order harmonic. The filtering circuit may be used to filter out the second-order harmonic so that the DC voltage level is inputted to the comparator 1215 to detect the signal.

FIG. 12B is a conceptual block diagram of an energy detection system 1260 according to an aspect of the disclosure. In this aspect, the energy detection system 1260 comprises an LNA 1240, one or more Radio Frequency (RF) amplifier stages 1250, and an energy detector 1230. In this aspect, the LNA 1240 and the one or more RF amplifiers stages 1250 amplify a signal received by the antenna 420, and the amplified signal is inputted to the energy detector 1230 for energy detection. An advantage of energy detection system 1260 according to this aspect is that it does not require a mixer and frequency synthesizer, which further reduces power consumption. The energy detection system 1260 may include a band-select filter (not shown) in front of the LNA 1240 to filter out out-of-band blockers. Further, load tuning circuits of the one or more RF amplifier stages 1250 may be configured to provide secondary filtering of out-of-band blockers.

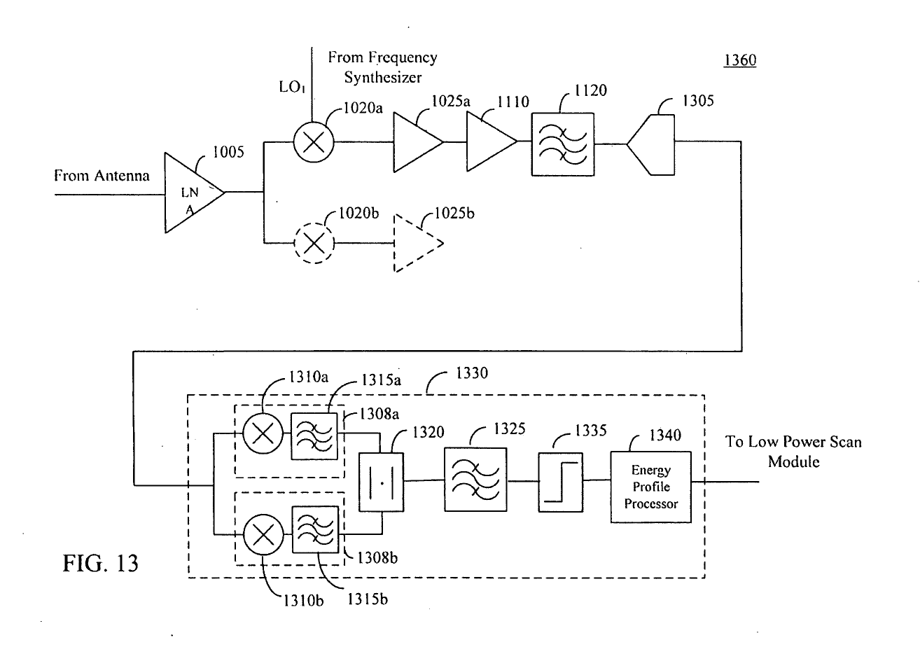

FIG. 13 is a conceptual block diagram of an energy detection system 1360 according to an aspect of the disclosure. The energy detection system 1360 comprises the LNA 1005, the mixer 1020a and the baseband amplifier 1025a of the receiver 1030 shown in FIG. 10. The energy detection system 1360 may also comprise a second amplifier 1110 and a band-pass filter 1120, which may be implemented as a combination of a high-pass filter and a low-pass filter.

The energy detection system 1360 may further comprise an analog-to-digital converter 1305 configured to sample the input signal from the band-pass filter 1120 (e.g., at a sampling rate of 32 MHz) and convert each sample of the signal into a digital value. In one aspect, the analog-to-digital converter may be implemented by a 1-bit sampler and quantizer 1305 that performs 1-bit quantization of the input signal if its threshold is set to zero or a small voltage to overcome DC offset in the system. The 1-bit sampler and quantizer 1305 may sample the input signal at a sampling rate of 32 MHz. With a 32 MHz sampling rate and a 1 MHz signal bandwidth (e.g., bandwidth of a page packet), the over sampling ratio is 32, which increases the effective dynamic range of the 1-bit sampler and quantizer. Other sampling rates may be used. In one aspect, the band-pass filter 1120 and/or amplifier 1110 may be configured to filter out aliasing components for the 1-bit sampler and quantizer 1305.

The output of the 1-bit sampler and quantizer 1305 may then be digitally processed by the energy detector 1330 to determine whether the energy of a page packet or inquiry packet is present. In this aspect, the energy detector 1330 may be implemented by a Digital Signal Processor (DSP) or other type of processor. In this aspect, the energy detector 1330 may comprise two mixers 1310a and 1310b, two baseband filters 1315a and 1315b, an envelope detector 1320, a second baseband filter 1325, a hard decision detector 1335, and an energy profile processor 1340.

In one aspect, the output signal of the 1-bit sampler and quantizer 1305 is split between an I and Q path 1308a and 1308b and frequency down-converted to baseband by the mixers 1310a and 1310b, respectively. The mixers may be implemented digitally by multiplying the signal in each path 1308a and 1308b with a repeating 0, +1, 0, −1 sequence. The sequences for the I and Q mixers may be shifted by 1 bit with respect to each other. The I and Q baseband signals are then filtered by the baseband filters 1315a and 1315b, respectively, to remove noise. The baseband filters 1315a and 1315b may have a bandwidth in the range of hundreds of KHz, e.g., 220 KHz. The I and Q filtered baseband signals are then inputted to the envelope detector 1320.

In one aspect, the envelope detector 1320 may perform the following operation:

D=\sqrt{I²+Q²} (2)

where D is the output of the envelope detector 1320, I is the I baseband signal, and Q is the Q baseband signal. Thus, the envelope detector 1320 in this aspect squares each of the I and Q baseband signals, and takes the square root of the sum of their squares.

In this aspect, the envelope detector 1320 removes the GFSK modulation of the I and Q baseband signals, and outputs a DC level providing a measure of the envelope of a page signal or an inquiry signal and, hence, the energy of a page signal or an inquiry signal. The output of the envelope detector 1320 may then be filtered by the second baseband filter 1325.

In one aspect, the second baseband filter 1325 may have a narrow bandwidth centered at DC to allow the detector output at DC to pass while attenuating signals away from DC. The second baseband filter 1325 may have a bandwidth in the range of tens of KHz, e.g., 25 KHz. Thus, the second baseband filter 1325 may be used to isolate the DC level outputted by the envelope detector by applying narrow-bandwidth filtering to the resulting signal. This technique may be used to filter out signals, e.g., that do not have a constant envelope.

The output signal from the second baseband filter 1325 may then be inputted to the hard decision detector 1335. The hard decision detector 1335 may be configured to compare the input signal with a hard decision threshold, and output a logic high when the input signal is above the hard decision threshold and a logic low when the input signal is below the hard decision threshold. The hard decision detector 1335 may have a sampling rate of 125 KHz or other sampling rate. Thus, the hard decision detector 1335 may make a hard decision of whether energy is present based on whether the input signal is above or below the hard decision threshold. The hard decision detector 1335 may have a programmable threshold, e.g., in the range of 0 to 255 bits.

The output of the hard decision detector 1335 may then be inputted to the energy profile processor 1340. In one aspect, the energy profile processor 1340 may be configured to measure the duration of energy detection by the hard decision detector 1335, and determine whether the duration of energy detection corresponds to the length of a page packet or an inquiry packet (e.g., 68 μs). The energy profile processor 1340 may measure the duration of energy detection, e.g., by counting a number of samples from the hard decision detector 1335 indicating detected energy within a time window. If the count within the time window is above a count threshold, then the energy profile processor 1340 may determine that the energy of a page packet or inquiry packet has been detected, and output a detection signal to the low power scan processor 448. The energy profile processor 1340 may use one or more counters (not shown) to count the number of samples indicating detected energy, and may receive a clock signal, e.g., Bluetooth clock, to keep track of time. Further, the energy profile processor 1340 may output a time stamp to the low power scan processor 448 indicating, e.g., a time that the energy of a page packet or inquiry packet is first detected.

In one aspect, the energy profile processor 1340 may determine whether two conditions are met before declaring the detection of a page packet or inquiry packet. The first condition may be that the number of samples indicating detected energy within a first time window be equal to or above a first count threshold. The first condition may be used to determine whether the duration of the energy detection is long enough to be from a page packet or inquiry packet (e.g., 68 μs). The second condition may be that the number of samples indicating detected energy within a second window be equal to or less that a second count value. The second condition may be used to determine whether the duration of the energy detection is too long to be from a page packet or inquiry packet, in which case, the detected energy may be from another signal (e.g., WLAN signal) that may interfere with a page packet or inquiry packet.

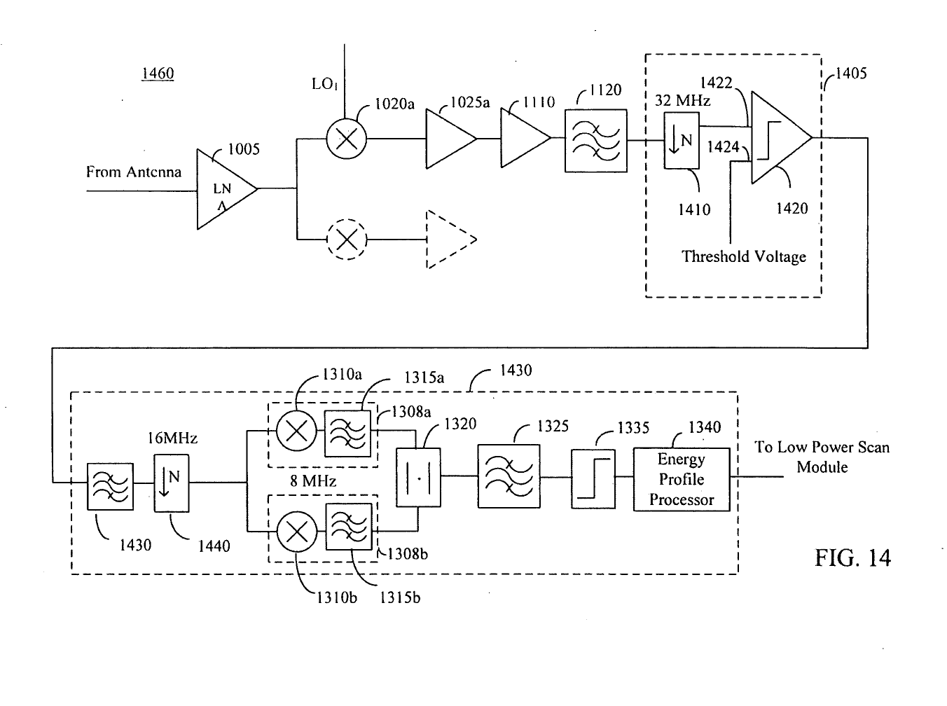

FIG. 14 is a conceptual block diagram of an energy detection system 1460 according to an aspect of the disclosure. In this aspect, the 1-bit sampler and quantizer 1205 comprises a sampler 1410 and a comparator 1420. In the example shown in FIG. 14, the sampler samples the signal from the band-pass filter 1120 at a sampling rate of 32 MHz, although other sampling rates may also be used. The output of the sampler 1410 is inputted to a first input 1422 of the comparator 1420. A voltage threshold is inputted to a second input 1424 of the comparator 1420. The threshold voltage may be approximately zero volts or a few millivolts. In one aspect, the comparator 420 may compare each sample from the sampler 1410 to the threshold voltage, and output a logic high when the sample is above the threshold and a logic low when the sample is below the threshold. The comparator 1420 may include a sampling capacitor (not shown) at input 1422 to hold the sample. The sampling capacitor may have a capacitance greater than 10 fF.

The energy detection system 1460 also comprises a second anti-aliasing filter 1430 and a decimator 1440 between the 1-bit sampler and quantizer 1205 and the mixers 1310a and 1310b. In one aspect, the decimator 1440 is configured to decimate the signal from the 1 bit sampler and quantizer to a sampling rate of 16 MHz. The second anti-aliasing filter 1430 may be configured to filter out aliasing components for a sampling rate of 16 MHz before decimation by the decimator 1440. In this aspect, the decimator 1440 decimates the signal to the mixers 1310a and 1310b to a sampling rate of 16 MHz to simplify the implementation of the mixers 1310a and 1310b for the case where IF is 4 MHz. This is because a sampling rate that is four times faster than the IF allows the mixers 1310a and 1310b to be implemented by multiplying the signal at each mixer 1310a and 1310b with a repeating sequence of 0, +1, 0, −1. Other sampling rates may be used for the decimator 1440, e.g., depending on the IF of the energy detection system 1460.

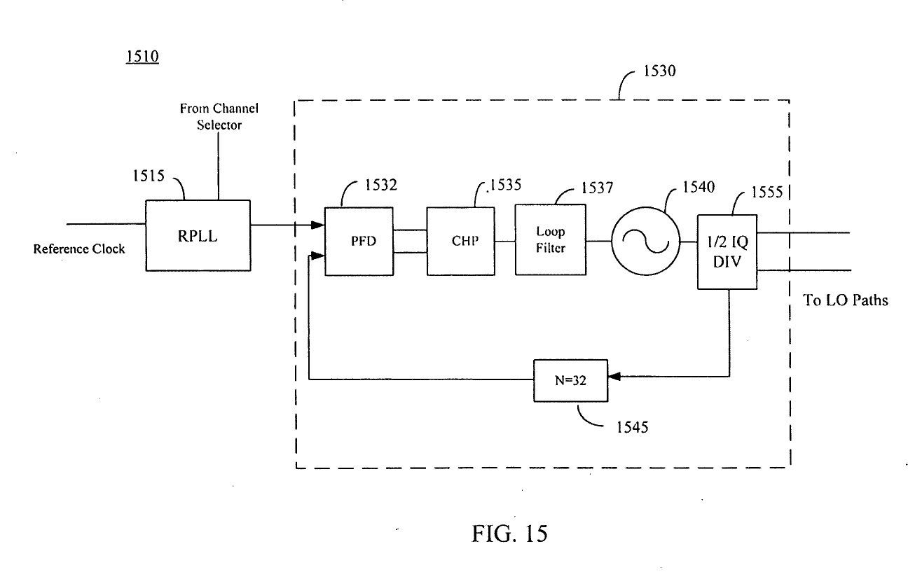

FIG. 15 is a conceptual block diagram of a frequency synthesizer 1510 according to an aspect of the disclosure. The frequency synthesizer 1510 may be used to implement the frequency synthesizer 1050 in FIG. 10 to generate the local oscillator signals LO_{I} and LO_{Q} for direct conversion of RF signals to baseband at the mixers 1020a and 1020b. The frequency synthesizer 1510 may comprise a Phase-Locked Loop PLL 1530 and a Reference PLL (RPLL) 1515.

In one aspect, the RPLL 1515 generates a reference signal having a tunable frequency from an input reference clock and outputs the reference signal to the PLL 1530. For example, the reference signal can be tuned within a frequency range of 75 MHz to 77.5 MHz based on a desired channel from the channel selector 446. The RPLL 1515 may be implemented using a fractional-N PLL or other type of PLL. The PLL 1530 receives the tunable reference signal from the RPLL 1515 and generates an oscillator signal from the reference signal, in which the oscillator signal has a frequency that can be tuned within a frequency range of 4.804 GHz to 4.960 GHz by tuning the frequency of the reference signal from the RPLL 1515. The oscillator signal may then be frequency divided by an IQ divide-by-2 divider 1555 to a frequency range of 2.402 GHz to 2.480 GHz and split into local oscillator signals LO_{I} and LO_{Q} for direct conversion of RF signals to baseband. In this aspect, the frequency of the local oscillator signals LO_{I} and LO_{Q} can be tuned in increments of 1 MHz within the frequency range 2.402 GHz to 2.480 GHz to select different channels by tuning the frequency of the reference signal from the RPLL 1515 inputted to the PLL 1530. The frequency ranges given above are exemplary only, and other frequency ranges may be used.

In one aspect, the PLL 1530 comprises a phase frequency detector (PFD) 1532, a charge pump 1535, a loop filter 1537, a voltage-controlled oscillator (VCO) 1540, the IQ divide-by-2 divider 1555, and a feedback frequency divider 1545. The loop filter may be used to provide stability and filtering to the feedback loop of the PLL 1530. In this aspect, the feedback frequency divider 1545 may divide the output signal of the VCO by a fixed integer (e.g., 32), which is fed to one of the inputs of the PFD 1532 to form a feedback loop. For an example where the frequency divider 1545 divides by 32, the total division along the feedback loop is 64 and the VCO 1540 generates a tunable oscillator signal having a frequency range of 4.804 GHz to 4.960 GHz when the reference signal has a frequency range of 75 GHz to 77.5 GHz.

In operation, the PFD 1532 compares the phases of the tunable reference signal and the VCO output signal divided by the frequency dividers 1545 and 1555 and outputs a phase error signal to the charge pump 1535 based on the phase difference between the two signals. The charge pump 1535 then injects current into or pulls current from capacitors (not shown) in the loop filter 1537 based on the phase error signal. The current injected into or pulled from the capacitors in the loop filter 1537 adjusts the voltage outputted by the loop filter 1537, which supplies the control voltage to the VCO 1540. The resulting adjustment of the control voltage to the VCO 1540 adjusts the frequency of the VCO 1540 in a direction that minimizes the phase error.

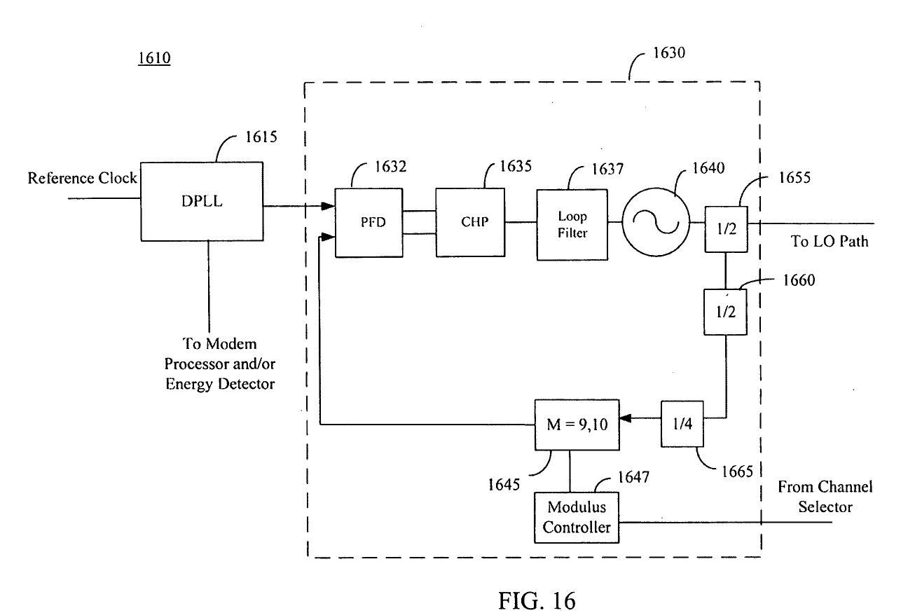

FIG. 16 is a conceptual block diagram of a frequency synthesizer 1610 according to an aspect of the disclosure. The frequency synthesizer 1610 may be used to implement the frequency synthesizer 1150 for the energy detection system 1160 in FIG. 11 to generate the local oscillator signals LO_{I} for down conversion of an RF signal to IF at the mixer 1020a. The frequency synthesizer 1610 in this aspect comprises a Digital PLL (DPLL) 1615 and a PLL 1630.

In one aspect, the DPLL 1615 may comprise a fractional-N PLL configured to generate a reference signal having a fixed frequency (e.g., 32 MHz) from a reference clock signal. The reference clock signal may come from a crystal oscillator, and may be the same reference clock signal inputted to the RPLL 1515 in FIG. 15. The DPLL 1615 may also be used to provide clock signals to the modem processor 430 for digital baseband processing and clock signals to the energy detector 1330 for digital processing. The DPLL 1615 generally consumes less power than the RPLL 1515 because digital processing can generally tolerate noisier clock signals. Using the DPLL 1615 in place of the RPLL 1515 allows the frequency synthesizer 1610 to reduce power consumption over the frequency synthesizer 1510 in FIG. 15. The DPLL 1615 may have more noise compared with the RPLL 1515. However, the energy detection system 1330 performs energy detection instead of data demodulation (e.g., GFSK demodulation) of a page packet, which relaxes the noise requirements for the frequency synthesizer 1610.

In one aspect, the DPLL 1615 outputs a fixed-frequency reference signal (e.g., 32 MHz) to the PLL 1630. The PLL 1630 comprises a phase frequency detector (PFD) 1632, a charge pump 1635, a loop filter 1637, a voltage-controlled oscillator (VCO) 1640, two divide-by-2 dividers 1655 and 1660, a divide-by-4 divider 1665 and a frequency divider 1645.

In one aspect, the frequency divider 1645 is configured to divide the frequency of the VCO output signal in the feedback loop by an adjustable fractional divisor. The frequency divider 1645 may be implemented using a dual-modulus divider that provides an adjustable fractional divisor between two integers (e.g., 9 and 10). In one aspect, the fractional divisor may be realized by toggling the frequency divider 1645 between 9 and 10, in which the fractional divisor is determined by the percentage of time the frequency divider 1645 spends on 9 and 10. In this aspect, a modulus controller 1647 may control the fractional divisor of the frequency divider 1645. The frequency divider 1645 may be configured to implement other fractional divisors besides fractional divisors between 9 and 10.

In one aspect, the frequency of the oscillator signal outputted by the PLL 1630 may be tuned by adjusting the fractional divisor of the frequency divider 1645 in the feedback path of the PLL 1630. In this aspect, the modulus controller 1647 may adjust the fractional divisor of the frequency divider 1645, and hence tune the frequency of the oscillator signal, based on a desired channel from the channel selector 446. The frequency of the oscillator signal may be tuned to down convert an RF signal corresponding to the desired channel to IF (e.g., 4 MHz) at the mixer 1020a. Thus, the oscillator signal in this aspect may be generated from a fixed-frequency reference signal from the DPLL 1615 and tuned by adjusting the fractional divisor of the frequency divider 1645.

The frequency synthesizer 1610 may use high-side or low-side injection to down convert an RF signal to IF. For example, for a channel corresponding to 2.432 GHz and an IF of 4 MHz, the oscillator output may be 2.436 GHz (high-side injection) or 2.428 (low-side injection) to down convert the RF signal to IF. The frequency synthesizer may alternate between the two types of injections. For example, if one of the types of injections is susceptible to spurs from the frequency divider at a certain channel, then the frequency synthesizer may use the other type of injection for that channel.

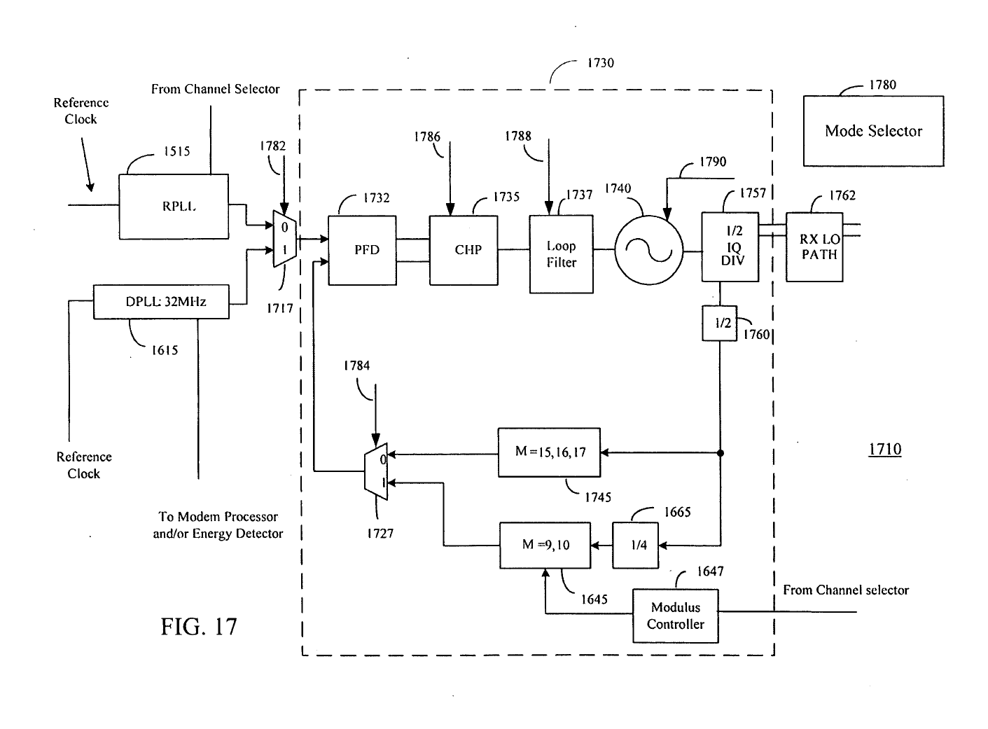

FIG. 17 is a conceptual block diagram of a dual-mode frequency synthesizer 1710 according to an aspect of the disclosure. The frequency synthesizer 1710 according to this aspect may operate in a page scan mode to generate the local oscillator signals LO_{I} and LO_{Q} for direct down conversion of an RF signal to baseband at the mixers 1020a and 1020b. The frequency synthesizer 1710 may also operate in an energy scan mode to generate the local oscillator signals LO_{I} for down conversion of an RF signal to IF at the mixer 1020a.

In one aspect, the frequency synthesizer 1710 comprises a DPLL 1615, a RPLL 1515, a switch 1717, and a PLL 1730. The switch 1717 couples either the DPLL 1615 or the RPLL 1515 to the PLL 1730 based on the mode of operation of the frequency synthesizer 1710. When the frequency synthesizer 1710 operates in a page scan mode, the switch 1717 couples the RPLL 1515 to the input of the PLL 1730. When the frequency synthesizer 1710 operates in an energy scan mode, the switch couples the DPLL 1615 to the input of the PLL 1730.

The PLL 1730 comprises a PFD 1732, a charge pump 1735, a loop filter 1737, and VCO 1740. The PLL 1730 further comprises two feedback paths to support the two modes of operation of the frequency synthesizer. A first feedback path comprises two divide-by-2 dividers 1757 and 1760 and a frequency divider 1745. A second feedback path comprises the two divide-by-2 1757 and 1760, a divide-by-4 divider 1665 and a frequency divider 1645. A switch 1727 couples either the first feedback path or the second feedback path to the input of the PFD 1732 depending on the mode of operation of the frequency synthesizer 1710. When the frequency synthesizer 1710 operates in a page scan mode, the switch 1727 couples the first feedback path to the input of the PFD 1732. When the frequency synthesizer 1710 operates in an energy scan mode, the switch 1727 couples the second feedback path to the input of the PFD 1732.

In one aspect, the loop filter 1737 may be programmable to adjust the loop bandwidth of the PLL 1730 for the different modes of operation. An example of a programmable loop filter is given below. Also, the charge pump 1735 may be programmable to adjust the current of the charge pump for the different modes of operation.

In one aspect, the VCO 1740 may have a programmable bias current. The bias current may be lowered in the energy scan mode to conserve power. Although lowering the bias current in the energy scan mode may increase the phase noise of the VCO 1740, the noise requirements of the energy detection system is relaxed compared with the receiver in the page scan mode. For example, the current of the charge pump in the energy scan mode may be reduced by 30% compared to the page scan mode.

In a page scan mode, the output signal of the VCO 1740 is frequency divided by the two divide-by-2 dividers 1757 and 1760 and the frequency divider 1745, and is fed back to the input of the PFD 1730 after frequency division. In one aspect, the frequency divider 1745 may be configured to frequency divide by 15, 16 or 17. When the frequency divider 1745 divides by 16, the total division along the first feedback loop is by 64, which is similar to the frequency synthesizer 1510 in FIG. 15. In this case, the frequency of the reference signal from the RPLL 1515 may be tuned between 75 GHz and 77.5 GHz to tune the local oscillator signals between 2.402 GHz and 2.480 GHz for channel selection. Certain channels may be susceptible to spurs from the RPLL 1525 when the frequency divider 1745 divides by 16. In these cases, the frequency divider 1745 may divide by 15 or 17 to avoid the spurs at these channels. When the frequency divider divides by 15 and 17, the frequency of the reference signal may need to be adjusted accordingly to tune the local oscillator signals to the desired channel. In one aspect, the divide-by-2 divider 1757 outputs the I and Q local oscillator signals LO_{I} and LO_{Q}, which are sent down the I and Q LO paths 1762 to the respective mixers 1020a and 1020b.

In an energy scan mode, the output signal of the VCO 1740 is frequency divided by the two divide-by-2 dividers 1757 and 1760, the divide-by-4 divider 1665, and the frequency divider 1645. The signal from the VCO 1740 is fed back to the input of the PFD 1730 after the frequency division. In an energy scan mode, the PLL 1730 may function similarly to the PLL 1630 in FIG. 16. In this mode, the PLL 1730 may function as a fractional-N PLL in which the frequency of the reference signal from the DPLL 1615 is fixed, and the frequency of the local oscillator signal is tuned by adjusting the fractional divisor of the frequency divider 1645. Also in this mode, the Q components of the IQ divider and the Q LO path may be shut down to conserve power since they are not used by the energy detection system.

In one aspect, the mode of operation of the frequency synthesizer 1710 may be controlled by a mode selector 1780, which may be implemented in the processing system 440. In one aspect, the mode selector 1780 may send control signals 1782 and 1784 to switches 1717 and 1727, respectively, to control which reference signal and feedback loop are used by the frequency synthesizer 1710. The control signal 1782 may be in the form of a 1-bit control signal, in which the switch 1717 couples the RPLL 1515 to the PFD 1732 when the bit value is zero and couples the DPLL 1615 to the PFD 1732 when the bit value is one. Similarly, the control signal 1784 may be in the form of a 1-bit control signal, in which the switch 1727 couples the first feedback loop to the PFD 1732 when the bit value is zero and couples the second feedback loop to the PFD 1732 when the bit value is one. In this aspect, the mode selector 1780 may output a bit value of zero for both control signals 1782 and 1784 in a page scan mode and a bit value of one for both control signals 1782 and 1784 in an energy scan mode. The control signals 1782 and 1784 may be the same.

In one aspect, the mode selector 1780 may send a control signal 1788 to the loop filter 1737 to control the loop bandwidth of the PLL 1730 based on the mode of operation of the frequency synthesizer 1710. For example, the mode selector 1780 may reduce the loop bandwidth of the PLL in the energy scan mode to filter out DPLL noise as well as attenuate fractional spurs generated by the fractional division of the frequency divider 1645.

In one aspect, the mode selector 1780 may send a control signal 1786 to the charge pump 1735 to control the current level of the charge pump 1735 based on the mode of operation of the frequency synthesizer 1710. For example, the mode selector may reduce the current of the charge pump 1735 in conjunction with the reduction in the loop bandwidth of the PLL in the energy scan mode to maintain adequate phase margin.

In one aspect, the mode selector 1780 may adjust the current bias 1790 to the VCO 1740 based on the mode of operation of the frequency synthesizer 1710. For example, the mode selector 1780 may lower the bias current in the energy scan mode to reduce power consumption with a tradeoff of higher VCO noise.

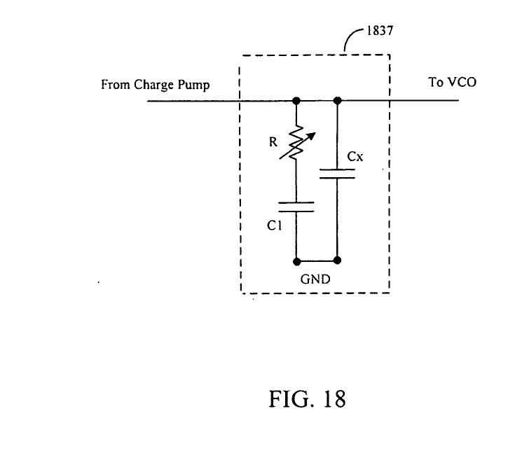

FIG. 18 is a conceptual block diagram of an programmable loop filter 1837 that may be used to implement the loop filter 1737 in FIG. 17 according to an aspect of the disclosure. The loop filter 1837 comprises a programmable resistor R, and two capacitors C1 and Cx. In this aspect, the loop bandwidth of the PLL 1730 can be adjusted by adjusting the resistance of the programmable resistor R. For example, the capacitors C1 and Cx may have values of 108 pF and 5.8 pF, respectively, and the programmable resistor R may have a resistance of 26.4 KΩ in the page scan mode and a resistance of 52.8 KΩ in the energy scan mode.

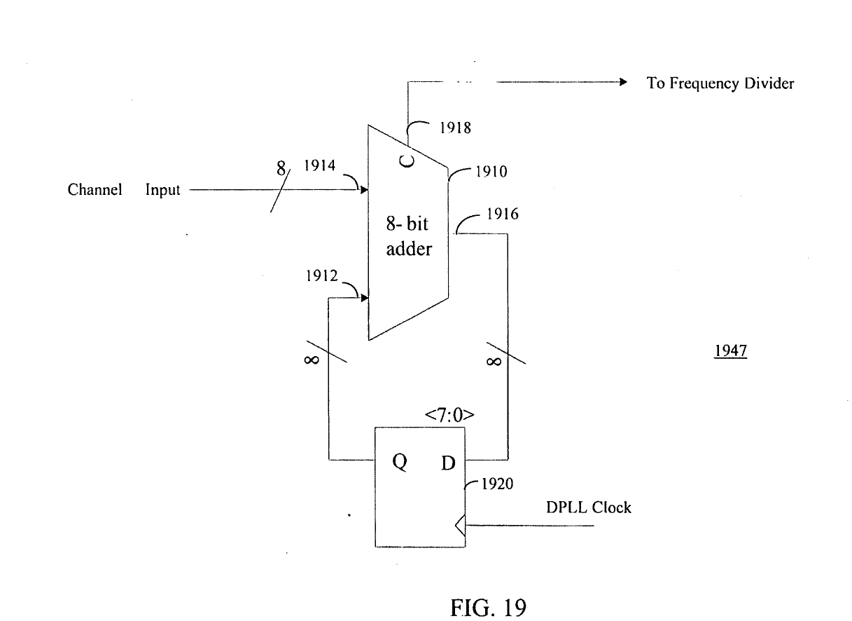

FIG. 19 is a conceptual block diagram of a modulus controller 1947 according to an aspect of the disclosure. The modulus controller 1947 may be used to implement the modulus controller 1647 in FIG. 17. The modulus controller 1947 in FIG. 19 is an example of a first-order delta-sigma modulator. The modulus controller 1947 comprises an accumulator 1910, and a D flip flop 1920. The accumulator 1910 may have two inputs 1914 and 1912, an accumulator output 1916, and an overflow output 1918. The accumulator 1910 may be an 8-bit accumulator. In this example, the accumulation output 1916 may output the sum of the two inputs 1914 and 1912 up to a value of 255. When the sum exceeds 255, the overflow output 1918 may send an overflow signal to the frequency divider 1645 and the accumulator output 1916 may output the difference between the sum and 255. In one aspect, the frequency divider 1645 may be configured to toggle to 10 when it receives the overflow signal from the accumulator 1910 and toggle back to 9 when it does not receive the overflow signal. In one aspect, the overflow signal may be in the form of a bit, where a bit value of one indicates an overflow. In this aspect, the overflow signal may act as a 1-bit control signal to the frequency divider to control toggling between 9 and 10, in which the frequency divider toggles to 10 when the control signal bit is one.

In one aspect, the accumulator output 1910 is fed back to the input 1912 of the accumulator through the D flip flop 1920. The other input 1914 of the accumulator receives a channel input. In this aspect, the D flip flop 1920 may be clocked by the DPLL (e.g., 32 MHz), in which the accumulator output 1920 is fed back to the input 1912 of the accumulator 1910 on every clock cycle.

In operation, the value of the channel input controls how frequently the accumulator overflows and outputs an overflow signal to the frequency divider. This in turn controls how frequently the frequency divider 1645 is toggled to 10, and hence the fractional divisor of the frequency divider 1645, which controls the frequency of the local oscillator signal. In one aspect, the channel input may have different values corresponding to different channels, in which a value corresponding to a desired channel is inputted to the accumulator 1910. The channel input may be provided by the channel selector, which may select channels based on a page channel hopping sequence or other channel hopping scheme.

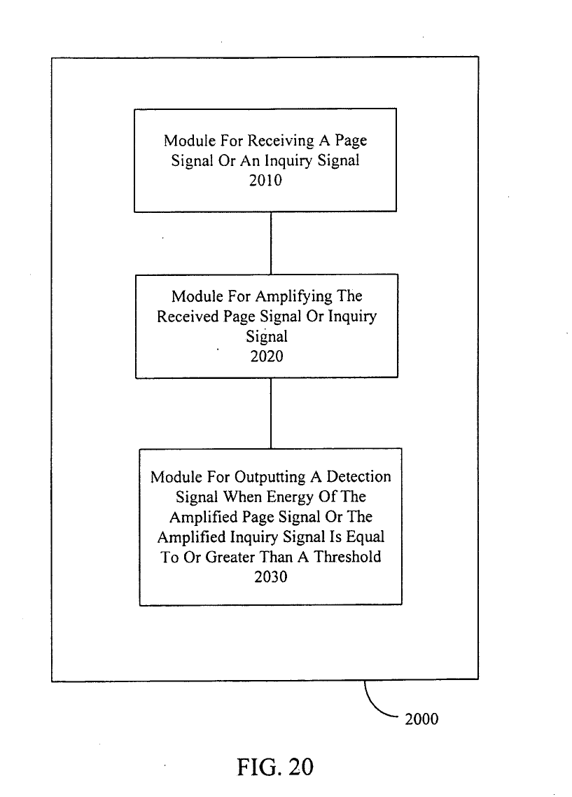

FIG. 20 is a conceptual block diagram illustrating an example of the functionality of an electronic device 2000 for communication. The electronic device comprises a module 2010 for receiving a page signal or an inquiry signal and a module 2020 for amplifying the received page signal or inquiry signal. The electronic device further comprises a module 2030 for outputting a detection signal when energy of the amplified page signal or the amplified inquiry signal is equal to or greater than a threshold.

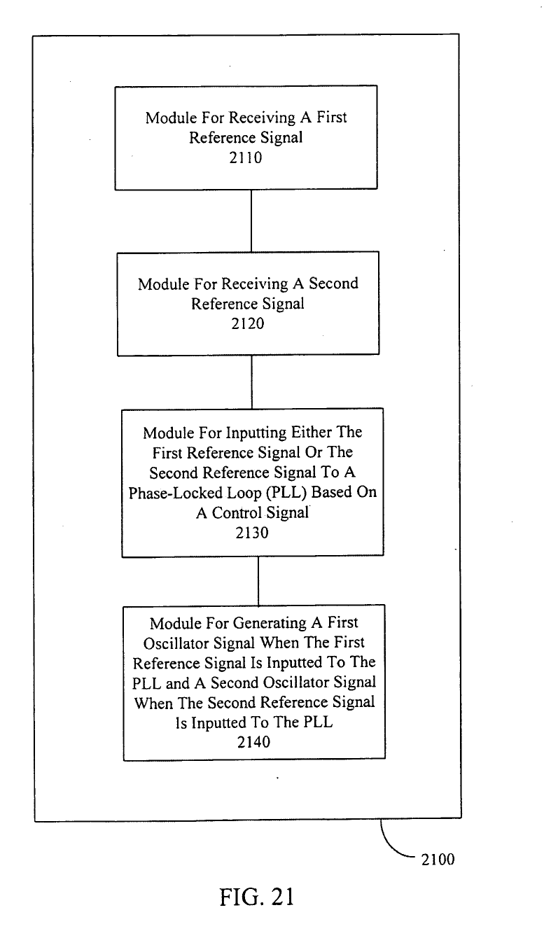

FIG. 21 is a conceptual block diagram illustrating an example of the functionality of an electronic device 2100 for communication. The electronic device comprises a module 2110 for receiving a first reference signal and a module 2120 for receiving a second reference signal. The electronic device 2100 further comprises a module 2130 for inputting either the first reference signal or the second reference signal to a Phase-Locked Loop (PLL) based on a control signal and a module 2140 for generating a first oscillator signal when the first reference signal is inputted to the PLL or generating a second oscillator signal when the second reference signal is inputted to the PLL.

Although the subject technology was described in the context of page scans and inquiry scans, the principles of the subject technology may be used to detect the energy of other types of packets. For example, the subject technology may be used to conserve power in applications where a device periodically scans for a packet of data by detecting the energy of the packet first, and performing a scan for the packet when its energy is detected. As another example, the subject technology may be applied in situations where a device scans for a packet of data that is transmitted on a repeating train by another device. The train may comprise a sequence of channels and may repeat every train interval. In this example, when the energy of the packet is detected, the scanning device may scan for the packet after approximately a train interval after the time of energy detection. Thus, the subject technology is not limited to the examples of page scans and inquiry scans. Further, the subject technology may be applied to page scans and inquiry scans used in other technologies besides Bluetooth.

Various components and blocks may be arranged differently (e.g., arranged in a different order, or partitioned in a different way) all without departing from the scope of the subject technology. For example, a functionality implemented in a processing system 440 of FIG. 4A may be implemented in a receiver 430, a transmitter 425, a modem processor 435, a machine-readable medium 445, and/or an energy detection system 460, and vice versa. A functionality implemented in an energy detection system 460 may be implemented in a receiver 430, a transmitter 425, a modem processor 435, a machine-readable medium 445, and/or a processing system 440, and vice versa.

By way of illustration and not limitation, an electronic device may be a cellular phone, a personal digital assistance (PDA) device, an audio device, a video device, a multimedia device, a game console, a laptop, a computer, a wireless headset, a wireless mouse, a wireless keyboard, a page scanning device, a Bluetooth enabled device, a processing system, a processor, or a component thereof, or any other electronic/optical device. By way of illustration and not limitation, an electronic device may include one or more integrated circuits. By way of illustration and not limitation, a page signal may include a page packet or a portion thereof.

Examples of particular communications protocols and formats have been given to illustrate the subject technology. However, the subject technology is not limited to these examples and applies to other communications protocols and formats.

Those of skill in the art would appreciate that the various illustrative blocks, units, elements, components, methods, and algorithms described herein may be implemented as electronic hardware, computer software, or combinations of both. To illustrate this interchangeability of hardware and software, various illustrative blocks, units, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An electronic device for communication, comprising:
a processor comprising:
a power scan module configured to receive an energy detection signal identifying detection of energy of a page signal or an inquiry signal, the power scan module configured to provide, upon receiving the energy detection signal, an instruction to perform a page scan or an inquiry scan.

2. The electronic device of claim 1, wherein the power scan module is configured to provide an instruction to start the page scan at a time approximately a page train interval after a time that the energy of the page signal is detected.

3. The electronic device of claim 1, wherein the power scan module is configured to provide an instruction to shorten a time duration of the page scan based on a time that the energy of the page signal is detected.

4. The electronic device of claim 1, wherein the processor comprises a channel selector configured to select a channel from one of a plurality of channels, each channel corresponding to a different frequency, and to tune an energy detection system to detect the energy of the page signal at the selected channel.

5. The electronic device of claim 4, wherein the channel selector is configured to tune a receiver to the selected channel to perform the page scan.

6. The electronic device of claim 4, wherein, when the energy detection system detects the energy of the page signal at the selected channel, the power scan module is configured to determine an expected subsequent channel in a page train comprising a sequence of channels based on the selected channel, and to instruct the channel selector to tune a receiver to the expected next channel to perform the page scan.

7. The electronic device of claim 4, wherein the channel selected is configured to select the channel based on a page channel hopping sequence.

8. The electronic device of claim 1, wherein, upon receiving the energy detection signal, the power scan module is configured to provide an instruction to turn on a modem processor to demodulate the page signal during the page scan.

9. The electronic device of claim 1, wherein, upon receiving the energy detection signal, the power scan module is configured to provide an instruction to turn on a receiver to receive the page signal during the page scan.

10. The electronic device of claim 1, wherein the processor comprises a page scan module configured to receive the instruction to perform the page scan from the power scan module, the page scan module configured to, upon receiving the instruction, to perform a page scan.

11. The electronic device of claim 1, wherein the page scan comprises demodulating the page signal, and the power scan module is configured to receive the energy detection signal without having the page signal demodulated.

12. A machine-readable medium comprising instructions executable by a processor, the instructions comprising code for:
receiving an energy detection signal identifying detection of energy of a page signal or an inquiry signal; and
upon receiving the energy detection signal, providing an instruction to perform a page scan or an inquiry scan.

13. The machine-readable medium of claim 12, wherein the code for providing the instruction to perform the page scan comprises code for:
providing an instruction to start the page scan at a time approximately a page train interval after a time that the energy of the page signal is detected.

14. The machine-readable medium of claim 12, wherein the code for providing the instruction to perform the page scan comprises code for:
providing an instruction to shorten a time duration of the page scan based on a time that the energy of the page signal is detected.

15. The machine-readable medium of claim 12, wherein the instructions further comprise code for:
selecting a channel from a plurality of channels, each channel corresponding to a different frequency; and
tuning an energy detection system to detect the energy of the page signal at the selected channel.

16. The machine-readable medium of claim 15, wherein the instructions further comprise code for:
tuning a receiver to receive the page signal at the selected channel during the page scan.

17. The machine-readable medium of claim 15, wherein the instructions further comprise code for:
determining an expected subsequent channel in a page train comprising a sequence of channels based on the selected channel; and
tuning a receiver at the expected next channel in the page train to receive the page signal during the page scan.

18. The machine-readable medium of claim 15, wherein the code for selecting the channel comprises code for:
selecting the channel based on a page channel hopping sequences.

19. The machine-readable medium of claim 11, wherein the instructions further comprise code for:
upon receiving the energy detection signal, providing an instruction to turn on a modem processor to demodulate the page signal during the page scan.

20. The machine-readable medium of claim 11, wherein the instructions further comprise code for:
upon receiving the energy detection signal, providing an instruction to turn on a receiver to receive the page signal during the page scan.

21. An electronic device for communication, comprising:
an energy detection system comprising:
an amplifier configured to amplify a page signal or an inquiry signal received by an antenna; and
an energy detector configured to receive the amplified page signal or amplified inquiry signal and to output a detection signal when energy of the amplified page signal or the amplified inquiry signal is equal to or greater than a threshold.

22. The electronic device of claim 21, wherein the energy detector comprises an envelope detector configured to remove Frequency Shift Keying (FSK) modulation from the amplified page signal, and
wherein the energy detector is configured to output the detection signal when energy of the amplified page signal with the FSK modulation removed is equal to or greater than the threshold.

23. The electronic device of claim 22, wherein the energy detector further comprises a filter configured to filter the amplified page signal with the FSK modulation removed, and
wherein the energy detector is configured to output the detection signal when energy of the filtered page signal is equal to or greater than the threshold.

24. The electronic device of claim 21, wherein the energy detector comprises an energy profile processor configured to measure a duration of energy detection, and
wherein the energy detector is configured to output the detection signal when the duration of energy detection is approximately equal to or greater than a duration of a page packet.

25. The electronic device of claim 21, wherein the energy detector comprises an energy profile processor configured to measure a duration of energy detection, and
wherein the energy detector is configured to output the detection signal when the duration of energy detection is equal to or greater than a first duration and is equal to or less than a second duration.

26. The electronic device of claim 25, wherein the first duration is based on a duration of a page packet.

27. The electronic device of claim 25, wherein the second duration is based on a duration of a packet of an interfering signal.

28. The electronic device of claim 21, further comprising:
a frequency synthesizer configured to generate an oscillator signal; and
a mixer configured to mix the page signal with the oscillator signal to down convert the page signal to an Intermediate Frequency (IF), wherein the amplifier is configured to amplify the page signal at the IF.

29. The electronic device of claim 28, further comprising a channel selector, wherein the frequency synthesizer is configured to tune the oscillator signal to a channel selected by the channel selector, each channel corresponding to a different frequency.

30. The electronic device of claim 29, wherein the channel selector is configured to select the channel based on a page channel hopping sequence.

31. The electronic device of claim 21, wherein the electronic device is configured to detect the energy of the amplified page signal and to output the detection signal without demodulating the page signal.

32. An electronic device for communication, comprising:
means for receiving a page signal or inquiry signal;
means for amplifying the received page signal or inquiry signal;
means for outputting a detection signal when energy of the amplified page signal or the amplified inquiry scan is equal to or greater than a threshold.

33. The electronic device of claim 32, further comprising:
means for removing Frequency Shift Keying (FSK) modulation from the amplified page signal; and
means for outputting the detection signal when the energy of the amplified page signal with the FSK modulation removed is equal to or greater than the threshold.

34. The electronic device of claim 32, further comprising:
means for measuring a duration of energy detection; and
means for outputting the detection signal when the duration of the energy detection is approximately equal to or greater than a duration of a page packet.

35. The electronic device of claim 32, further comprising:
means for measuring a duration of energy detection; and
means for outputting the detection signal when the duration of the energy detection is equal to or greater than a first duration and equal to or less than a second duration.

36. The electronic device of claim 35, wherein the first duration is based on a duration of a page packet.

37. The electronic device of claim 35, wherein the second duration is based on a duration of a packet of an interfering signal.

38. The electronic device of claim 32, further comprising:
means for mixing the page signal with an oscillator signal to down convert the page signal to an Intermediate Frequency (IF), wherein the page signal is amplified at the IF.

39. The electronic device of claim 38, further comprising:
means for tuning the oscillator signal to one of a plurality of channels, each channel corresponding to a different frequency.

40. The electronic device of claim 39, further comprising:
means for selecting the channel based on a page channel hopping sequence.

41. An electronic device for communication, comprising:
a frequency synthesizer, comprising:
a first reference signal generator configured to generate and output a first reference signal;
a second reference signal generator configured to generate and output a second reference signal;
a Phase-Locked Loop (PLL) configured to generate a first oscillator signal from the first reference signal and to generate a second oscillator signal from the second reference signal; and
a switch configured to input either the first reference signal to the PLL or the second reference signal to the PLL based on a control signal.

42. The electronic device of claim 41, wherein the PLL comprises:
a first feedback loop; and
a second feedback loop, wherein the PLL is configured to use the first feedback loop to generate the first oscillator signal when the first reference signal is inputted to the PLL and to use the second feedback loop to generate the second oscillator signal when the second reference signal is inputted to the PLL.

43. The electronic device of claim 42, further comprising a channel selector, wherein the second feedback loop comprises a frequency divider configured to divide the second oscillator signal in the second feedback loop by an adjustable fractional divisor based on a first channel selected by the channel selector.

44. The electronic device of claim 43, wherein the first signal generator is configured to tune a frequency of the first reference signal based on a second channel selected by the channel selector.

45. The electronic device of claim 41, wherein the PLL comprises a loop filter configured to adjust a loop bandwidth of the PLL based on a second control signal.

46. An electronic device for communication, comprising:
means for receiving a first reference signal;
means for receiving a second reference signal;
means for inputting either the first reference signal or the second reference signal to a Phase-Locked Loop (PLL) based on a control signal; and
means for generating a first oscillator signal when the first reference signal is inputted to the PLL or generating a second oscillator signal when the second reference signal is inputted to the PLL.

47. The electronic device of claim 46, further comprising:
means for selecting a first feedback loop in the PLL to generate the first oscillator signal when the first reference signal is inputted to the PLL; and
means for selecting a second feedback loop in the PLL to generate the second oscillator signal when the second reference signal is inputted to the PLL.

48. The electronic device of claim 47, further comprising:
means for selecting a first channel from a plurality of channels;
means for dividing the second oscillator signal in the second feedback loop by an adjustable fractional divisor; and
means for adjusting the fractional divisor based on the first channel.

49. The electronic device of claim 48, further comprising:
means for selecting a second channel from the plurality of channels; and
means for tuning a frequency of the first reference signal based on the second channel.

50. The electronic device of claim 46, further comprising:
means for adjusting a loop bandwidth of the PLL based on a second control signal.

51. An electronic device for communication, comprising:
a processor comprising:
a power scan module configured to receive an energy detection signal identifying detection of energy of a signal including a packet of data, the power scan module configured to provide, upon receiving the energy detection signal, an instruction to perform a scan for the packet of data.

52. The electronic device of claim 51, wherein the packet of data is transmitted on a repeating train, the train comprising a sequence of channels, wherein the power scan module is configured to provide an instruction to start the scan at a time approximately a train interval after the time that the energy of the packet is detected.
